(19) United States
(12) Patent Application Publication
(10) Pub. No.: US 2008/0254382 A1
(43) Pub. Date: Oct. 16, 2008

(54) Heat-sensitive transfer sheet and image-forming method

(75) Inventors: Nobuyuki Haraguchi, Ashigarakami-gun (JP); Hidekazu Sakai, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/056,194

(22) Filed: Mar. 26, 2008

(30) Foreign Application Priority Data
Mar. 27, 2007 (JP) 2007-082579

(51) Int. Cl. G03G 5/12

(52) U.S. Cl. 430/200; 430/270.1

(57) ABSTRACT

A heat-sensitive transfer sheet comprising at least three different kinds of heat-sensitive transfer dye layers each comprising at least one yellow, magenta or cyan dye and at least one binder resin, provided on a support, and at least one thermal transferable protective layer capable of peeling, comprising a releasing layer, a peeling layer and an adhesion layer, provided on the support in this order, and

wherein a surface of the support to which the releasing layer of said protective layer adheres has been subjected to an atmospheric pressure plasma treatment.

### FIELD OF THE INVENTION

The present invention relates to a heat-sensitive transfer sheet that has reduced irregular transfer of a thermal transferable protective layer and that is excellent in print image quality, and to an image-forming method using the same.

### BACKGROUND OF THE INVENTION

Various heat transfer recording methods have been known so far. Among these methods, dye diffusion transfer recording systems attract attention as a process that can produce a color hard copy having an image quality closest to that of silver halide photography (see, for example, “Joho Kiroku (Hard Copy) to Soon Zairyo no Shintenkai (Information Recording (Hard Copy) and New Development of Recording Materials)” published by Toray Research Center Inc., 1993, pp. 241-285; and “Printer Zairyo no Kaihatsu (Development of Printer Materials)” published by CMC Publishing Co., Ltd., 1995, p. 180). Moreover, this system has advantages over silver halide photography: it is a dry system, it enables direct visualization from digital data, it makes reproduction simple, and the like.

In this dye diffusion transfer recording system, a heat-sensitive transfer sheet (hereinafter also referred to as an ink sheet) containing dyes is superposed on a heat-sensitive transfer image-receiving sheet (hereinafter also referred to as an image-receiving sheet), and then the ink sheet is heated by a thermal head whose exothermic action is controlled by electric signals, in order to transfer the dyes contained in the ink sheet to the image-receiving sheet, thereby recording an image information. Three colors: cyan, magenta, and yellow, are used for recording a color image by overlapping one color to other, thereby enabling transferring and recording a color image having continuous gradation for color densities.

Further, current heat-sensitive transfer sheets have a thermal transferable protective layer for improvement of scratch resistance and glossiness in addition to the above-described ink sheet. The thermal transferable protective layer is generally composed of binder layers such as a releasing layer, a peeling layer and an adhesion layer. In order to improve glossiness of the print, it is preferred that peeling occurs between particular layers of the releasing layer and the peeling layer. Recently, with a speeding-up of the print, there is a demand for transfer of the thermal transferable protective layer by heating in a short period of time. However, a quantity of heat per unit hour from a thermal head increases under the conditions of high speed print. Therefore, peeling does not occur between the above-described particular layers, but an irregular transfer occurs between a substrate (a surface of the substrate of thermal transferable sheet to which the thermal transferable protective layer adheres) and a binder layer adjacent to the substrate. Consequently, some problems such as deterioration of smoothness and glossiness arose owing to the irregular transfer. Further, it was found that when the heat-sensitive transfer sheet was used in combination with the heat-sensitive transfer image-receiving sheet having a heat insulation layer containing hollow polymer particles, especially having water-based coatings, the above described problems owing to the irregular transfer were further worsened. Therefore, it was necessary to improve such the irregular transfer.

It is known that such an irregular transfer also occurs to a heat-sensitive transfer dye layer (hereinafter also referred to as a dye layer). By the irregular transfer, not only a dye in the dye layer, but also together with a binder in the dye layer is transferred. For improvement of these problems, it is proposed to perform a surface treatment such as corona discharge treatment, plasma treatment, and low temperature plasma treatment on a substrate (see JP-A-10-181229 and JP-A-2006-116892, “JP-A” means unexamined published Japanese patent application). However, improvement by these methods was insufficient in such the points that the surface treatment lacked uniformity, and damage to a substrate remained because the substrate was thin in thickness.

Further, it is proposed to deter the irregular transfer of the ink sheet by coating an adhesive binder on a substrate, followed by stretching (see Japanese Patent No. 3124534). However, this method was also insufficient in the points of simplicity of the surface treatment and the cost of the substrate necessary to manufacture the heat-sensitive transfer sheet. Accordingly, it was necessary to find out a way how to further improve the above-described problems.

### SUMMARY OF THE INVENTION

The present invention resides in a heat-sensitive transfer sheet comprising at least three different kinds of heat-sensitive transfer dye layers each comprising at least one yellow, magenta or cyan dye and at least one binder resin, and a heat transferable protective layer capable of peeling, comprising a releasing layer, a peeling layer and an adhesion layer, provided on the support in this order, and wherein a surface of the support to which the releasing layer of said protective layer adheres has been subjected to an atmospheric (ordinary) pressure plasma treatment.

Further, the present invention resides in an image-forming method using a combination of said heat-sensitive transfer sheet and a heat-sensitive transfer image-receiving sheet, wherein said heat-sensitive transfer image-receiving sheet has a support, at least one receptor layer on the support and at least one heat insulation layer containing hollow polymer particles between the receptor layer and the support, and wherein the receptor layer and/or the heat insulation layer contains a hydrophilic polymer.

Other and further features and advantages of the invention will appear more fully from the following description.

### DETAILED DESCRIPTION OF THE INVENTION

The present invention provides the following means:

(1) A heat-sensitive transfer sheet comprising at least three different kinds of heat-sensitive transfer dye layers each comprising at least one yellow, magenta or cyan dye and at least one binder resin, provided on a support, and a thermal transferable protective layer capable of peeling, comprising a releasing layer, a peeling layer and an adhesion layer, provided on the support in this order, and

wherein a surface of the support to which the releasing layer of said protective layer adheres has been subjected to an atmospheric pressure plasma treatment.

(2) The heat-sensitive transfer sheet described in (1), wherein gas for use in said atmospheric pressure plasma treatment is a mixed gas substantially consisting of nitrogen and oxygen.

(3) The heat-sensitive transfer sheet described in (1) or (2), wherein said at least three heat-sensitive transfer dye layers are formed in area order, on the surface of the same support.

(4) The heat-sensitive transfer sheet described in (1) or (2), wherein each of said at least three heat-sensitive transfer dye layers and said thermal transferable protective layer is formed in area order, on the surface of the same support.

(5) An image-forming method using a combination of the heat-sensitive transfer sheet described in any one of (1) to (4) and a heat-sensitive transfer image-receiving sheet, wherein said heat-sensitive transfer image-receiving sheet has a support, at least one receptor layer on the support and at least one heat insulation layer containing hollow polymer particles between the receptor layer and the support, and wherein the receptor layer and/or the heat insulation layer contains a hydrophilic polymer.

(6) The image-forming method described in (5), wherein at least one of the hydrophilic polymer contained in the heat-sensitive transfer image-receiving sheet is gelatin.

(7) The image-forming method described in (5) or (6), which comprises coating at least two layers adjacent to each other of said at least one heat insulation layer and said at least one receptor layer by a simultaneous multilayer coating in the heat-sensitive transfer image-receiving sheet.

(8) The image-forming method described in any one of (5) to (7), comprising the steps of:

superposing the heat-sensitive transfer sheet on the heat-sensitive transfer image-receiving sheet so that the receptor layer of the heat-sensitive transfer image-receiving sheet is in contact with the heat-sensitive transfer dye layer of the heat-sensitive transfer sheet; and

giving thermal energy from a thermal head in accordance with image signals, thereby to form an image.

The present invention is explained in detail below.

As a result of the present inventors' intensively studying, it was found that a thermal transferable protective layer could be prevented from irregular transfer and also glossiness could be improved by subjecting the surface of the substrate to an atmospheric pressure plasma treatment. Further, it was found that the above-described task was more effectively accomplished by virtue of certain heat-sensitive transfer image-receiving sheets that were used in combination with the protective layer. Especially, it was found that by subjecting the surface of the substrate to atmospheric pressure plasma treatment, not only a thermal transferable protective layer could be prevented from irregular transfer, but also surprisingly rather glossiness was extremely effective in a particular heat-sensitive transfer image-receiving sheet. It was confirmed that glossiness in such the particular heat-sensitive transfer image-receiving sheet was improved as compared to other image-receiving sheets. The present invention has been accomplished in accordance with those findings.

### <Heat-Sensitive Transfer Sheet>

The heat-sensitive (thermal) transfer sheet of the present invention is preferably formed by the steps of applying an atmospheric pressure plasma treatment onto the surface of a substrate opposite to a heat-resistant lubricating layer disposed on one surface of the substrate, namely the surface of the substrate on which a protective layer binder liquid is coated, and thereafter disposing a heat-sensitive transfer dye layer and a thermal transferable protective layer. From the viewpoint of preventing a dye layer from irregular transfer, it is preferred that said atmospheric pressure plasma treatment is applied to the surface of a substrate on which the dye layer is coated.

### (Heat-Sensitive Transfer Dye Layer)

The heat-sensitive (thermal) transfer dye layer may be composed of a monochromatic single layer. Alternatively, a plurality of dye layers each having a different color hue from each other may be repeatedly formed in area order on the same surface of the same substrate. The heat-sensitive transfer dye layer is a layer in which a thermally migrating dye is carried by an arbitrary binder. The dye that can be used is a dye capable of migrating by melting, diffusion, or sublimation upon heating. Any dyes that are used in the sublimation diffusion type heat-sensitive transfer sheets conventionally known may be used in the present invention. However, the dyes are selected in consideration of color hue, printing sensitivity, light fastness, storage stability, solubility into a binder, and the like.

The term “forming layers in area order” as used herein means forming heat-sensitive transfer dye layers each having a different hue and/or function layers in the longitudinal direction on the support of the heat-sensitive transfer sheet, by applying them separately in order. In other words, the term “layers in area order” used herein means not a laminate of said layers but layers next to each other arranged or provided in the longitudinal direction on the support, which are obtained by repeating the following (a) and (b):

forming a layer at an area on the support, and
forming another layer at adjacent area to the area formed in (a) on the support in the longitudinal direction on the support.

Examples include the case in which a yellow heat transfer layer, a magenta heat transfer layer, and a cyan heat transfer layer are formed in this order in the longitudinal direction on the support.

Further, any arrangement of these heat-sensitive transfer dye layers can be employed, but it is preferred that a yellow heat transfer layer, a magenta heat transfer layer, and a cyan heat transfer layer be arranged sequentially in this order on the support.

Arrangement of the heat transfer layers of different hues in the present invention is not limited to the above, and a black or other heat transfer layer of a hue other than yellow, magenta, and cyan can be employed as required. Further, it is preferred to form a transferable protective layer (a transferable protective layer laminate) as a function layer, after forming the yellow heat transfer layer, the magenta heat transfer layer, and the cyan heat transfer layer in the longitudinal direction on the support, as mentioned above.

Preferable examples of the dye include diarylmethane-series dyes, triarylmethane-series dyes, thiazole-series dyes, methine-series dyes such as merocyanine, pyrazolonemethine, azomethine-series dyes typically exemplified by indoaniline, acetophenoneazomethine, pyrazoloazomethine, imidazole azomethine, imidazo azomethine, and pyridone azomethine, xanthene-series dyes, oxazine-series dyes, cyanomethylene-series dyes typically exemplified by dicyanostyrene, and tricyanostyrene, thazine-series dyes, azine-series dyes, acridine-series dyes, benzene azo-series dyes, azo-series dye such as pyridone azo, thiophene azo, isothiazole azo, pyrol azo, pyralazo, imidazole azo, thiadiazole azo, triazole azo, disazo, spiropyran-series dyes, indolinospiropyran-series dyes, fluoran-series dyes, rhodaminelactam-series dyes, naphthoquinone-series dyes, anthraquinone-series dyes, and quinophthalon-series dyes.

As a resin binder of the dye layer, there can be used any resin binders conventionally known. Examples of preferable resin binders include cellulose resins such as ethyl cellulose, hydroxyethyl cellulose, ethyl hydroxycellulose, hydroxypropyl cellulose, methyl cellulose, cellulose acetate, and cellulose butyrate, vinyl resins such as polyvinyl alcohol, polyvinyl acetate, polyvinyl butyral, polyvinyl acetal, polyvinyl pyrrolidone, and polyacryl amide, polyester resins, and phenoxy resins. Of these resins, especially preferred are cellulosic resins, acetal resins, butyral resins, polyester resins, and phenoxy resins from the viewpoints such as heat resistance and mobility of dyes.

Further, in place of the above-described resin binders, the following releasing graft copolymers may be used as a releasing agent or a binder in the present invention. The releasing graft copolymer has a molecular structure that is obtained by graft polymerizing at least one releasing segment selected from a polysiloxane segment, a fluorinated carbon segment, and a long chain alkyl segment to a polymer backbone chain. Of these polymers, especially preferred are graft copolymers that are obtained by graft polymerizing polysiloxane segments to polyvinyl acetal resin backbone chains.

To the heat-sensitive transfer dye layer, there may be added the above-described dyes, resin binders, and various kinds of other additives as conventionally known in accordance with necessity. Examples of the additives include organic particles such as polyethylene waxes and inorganic particles that are used to improve releasing properties between the heat-sensitive transfer dye layer and the image-receiving sheet, and also a coating suitability of the ink. Generally, such the dye layer can be formed by adding the above-described dyes, resin binders, and if necessary, other additives in a suitable solvent, and then dissolving or dispersing each of theses components in the solvent to prepare a coating liquid, and thereafter coating the coating liquid on a substrate, followed by drying. As a coating method, there can be used known methods such as a gravure printing method, a screen printing method, and a reverse roll coating method using a gravure printing plate.

A coating amount of the heat-sensitive transfer dye layer (hereinafter, also referred to as a heat-sensitive transfer layer) is preferably in the range of from 0.1 to 1.0 g/m² (solid basis, hereinafter, the amount to be applied in the present specification means a value on solid basis, unless otherwise specified), more preferably 0.15 to 0.60 g/m². A film thickness of the heat-sensitive transfer dye layer is preferably in the range of from 0.1 μm to 2.0 μm, more preferably from 0.1 μm to 1.0 μm.

In the heat-sensitive transfer sheet of the present invention, it is possible to dispose an adhesion layer such as polyvinyl pyrrolidone resins, polyurethane resins, phenol resins, and polyester resins between the atmospheric pressure plasma treated substrate and the heat-sensitive transfer dye layer. Further, after coating the adhesion layer, a surface of the adhesion layer may have been subjected to an atmospheric pressure plasma treatment. The adhesion layer can be formed by dissolving or dispersing a binder and, if necessary, additives in a water, or a water-based solvent such as alcohol, or an organic solvent to prepare a coating liquid, and thereafter coating the coating liquid using known methods such as a gravure printing method, a screen printing method, and a reverse roll coating method using a gravure printing plate. A dry coating amount of the thus-prepared adhesion layer is preferably in a range of from 0.05 g/m² to 0.3 g/m². If the coating amount is too small, irregularity of the substrate can not be made flat. Resultantly, uncoated portions occur, so that it is difficult to obtain a satisfactory effect. On the other hand, when the coating amount of the adhesion layer is larger than the above-described range, the adhesion layer and a heat-sensitive transfer dye layer become easy to mix with each other at the time when the heat-sensitive transfer dye layer is coated. Resultantly, a receptor layer becomes easy to be taken out to the heat-sensitive transfer dye layer side.

### <Thermal Transferable Protective Layer>

In addition to a yellow heat-sensitive transfer dye layer, a magenta heat-sensitive transfer dye layer, and a cyan heat-sensitive transfer dye layer, the heat-sensitive transfer sheet of the present invention has a thermal transferable protective layer capable of peeling in the rear of said layers. A thermal transferable protective layer capable of peeling that can be used in the heat-sensitive transfer sheet of the present invention is explained in detail below.

For example, the thermal transferable protective layer used in the present invention has a laminated structure consisting of at least two layers, namely at least a peeling layer containing an acrylic resin as a primary component and an adhesion layer containing a polyester resin as a primary component disposed in this order on a substrate sheet.

### (Peeling Layer)

As the thermal transferable protective layer that can be used in the present invention, there can be properly used resins that are excellent in abrasion resistance, transparency, hardness and the like. Specifically, examples of the resins include polyester resins, polystyrene resins, acrylic resins, polyurethane resins, acrylic urethane resins, vinyl chloride-vinyl acetate copolymer resins, silicone-modified resins of these resins, and a mixture of these resins. Further, use can be also made of resins that can be produced by cross-linking and hardening acrylic monomers or the like upon irradiation of ionizing radiation.

Examples of the above-described conventionally known acryl-series monomers include methyl acrylate, methyl methacrylate, ethyl acrylate, ethyl methacrylate, propyl acrylate, propyl methacrylate, butyl acrylate, butyl methacrylate, isobutyl acrylate, isobutyl methacrylate, tertiary butyl acrylate, tertiary butyl methacrylate, isodecyl acrylate, isodecyl methacrylate, lauryl acrylate, lauryl methacrylate, lauryl tridecylacrylate, lauryl tridecylmethacrylate, tridecylacrylate, tridecylmethacrylate, cetylstearylacrylate, cetylstearylmethacrylate, 2-ethylhexyl acrylate, 2-ethylhexyl methacrylate, octyl acrylate, octyl methacrylate, cyclohexyl acrylate, cyclohexyl methacrylate, benzyl acrylate, benzyl methacrylate, phenoxyethyl acrylate, phenoxyethyl methacrylate, isobornyl acrylate, isobornyl methacrylate, dicyclopentenyl acrylate, dicyclopentenyl methacrylate, methacrylic acid, 2-hydroxyethyl acrylate, 2-hydroxyethyl methacrylate, 2-hydroxypropyl acrylate, 2-hydroxypropyl methacrylate, dimethylaminoethyl acrylate, dimethylaminoethyl methacrylate, diethylaminoethyl acrylate, diethylaminoethyl methacrylate, tertiary butyl aminoethyl acrylate, tertiary butylaminoethyl methacrylate, glycidyl acrylate, glycidyl methacrylate, and tetrahydrofurfuryl methacrylate.

Additional examples of the acryl-series monomers include ethylene diacrylate, ethylene dimethacrylate, diethyleneglycol diacrylate, diethylene glycol dimethacrylate, triethyleneglycol diacrylate, triethylene glycol dimethacrylate, tetraethyleneglycol diacrylate, tetraethylene glycol dimethacrylate, decaethyleneglycol diacrylate, decaethylene glycol dimethacrylate, pentadecaethyleneglycol diacrylate, pentadecaethylene glycol dimethacrylate, pentacontahectaethyleneglycol diacrylate, pentacontahectaethylene glycol dimethacrylate, butylene diacrylate, butylene dimethacrylate, allyl acrylate, allyl methacrylate, trimethylolpropane triacrylate, trimethylolpropane trimethacrylate, 1,6-hexanediol diacrylate, 1,6-hexanediol dimethacrylate, tripropyleneglycol diacrylate, tripropylene glycol dimethacrylate, pentaerythritol tetraacrylate, pentaerythritol tetramethacrylate, dipentaerythritol hexaacrylate, dipentaerythritol hexamethacrylate, neopentylglycol pentaacrylate, neopentylglycol pentamethacrylate, phosphagen hexaacrylate, and phosphagen hexamethacrylate. As the ionizing radiation curable material, not only the above-described monomers but also oligomers thereof may be used.

Further, the above-described monomers may be used in combination with acrylic resins such as polyester acrylate-series, epoxy acrylate-series, urethane acrylate-series, and polyether acrylate-series resins, each of which is composed of a polymer or its derivative of the above-described monomers. Further, taking a film separating property of these resins at the time of transfer into consideration, it is also possible to contain therein fine particles or waxes each having a high transparency such as silica, alumina, calcium carbonate, and plastic pigments in such an addition quantity that their transparencies are not deteriorated. Further, lubricants may be contained therein in order to improve properties of the image such as friction resistance and gloss. Further in order to improve light fastness of the image, it is also possible to contain therein a light stabilizer, an antioxidant, or an ultraviolet absorber as described later in detail. The acrylic resin used in the present invention is preferred to have a molecular weight of from 20,000 to 100,000. If the molecular weight is too small, oligomers are produced at the time of synthesis, so that a stable performance cannot be obtained. On the other hand, if the molecular weight is too large, a so-called “foil-off” deteriorates at the time of transfer of the thermal transferable protective layer.

In the thermal transferable protective layer that is used in the present invention, ultraviolet absorbers are preferably contained in a peeling layer and/or an adhesion layer. As the ultraviolet absorber, use can be made of conventionally known inorganic ultraviolet absorbers and organic ultraviolet absorbers. As the organic ultraviolet absorbing agents, use can be made of non-reactive ultraviolet absorbing agents such as salicylate-series, benzophenone-series, benzotriazole-series, triazine-series, substituted acrylonitrile-series, nickel chelate-series, and hindered amine-series ultraviolet absorbing agents; and copolymers or graft polymers of thermoplastic resins (e.g., acrylic resins) and activated products obtained by introducing to the above-described non-reactive ultraviolet absorbing agents; addition-polymerizable double bonds originated from a vinyl group, an acryroyl group, a methacryroyl group, or the like, or alternatively by introducing thereto other types of groups such as an alcoholic hydroxyl group, an amino group, a carboxyl group, an epoxy group, and an isocyanate group. Of these ultraviolet absorbing agents, preferred are organic ultraviolet absorbing agents as described below, especially benzophenone-series, benzotriazole-series, and triazine-series ultraviolet absorbing agents. It is preferred that these ultraviolet absorbers are used in combination of plural materials having a different system from each other so as to cover an effective ultraviolet absorbing wavelength region in accordance with characteristics of the dyes that are used for image formation. With respect to non-reactive ultraviolet absorbers, it is preferred that plural materials having a different structure from each other are used in combination in order to prevent the ultraviolet absorber from deposition.

The ultraviolet absorber may be contained as ultraviolet absorbing resins. As the ultraviolet absorbing resin, for example, use can be made of resins that are obtained by reacting and bonding a reactive ultraviolet absorber with a thermoplastic resin or an ionizing radiation curable resin. More specifically, as the reactive ultraviolet absorber, there can be exemplified compounds that are obtained by introducing a reactive group such as an addition polymerizable double bond (e.g., a vinyl group, an acryloyl group, a methacryloyl group), an alcoholic hydroxyl group, an amino group, a carboxyl group, an epoxy group, and an isocyanate group into conventionally known non-reactive organic ultraviolet absorbers such as salicylate-series, benzophenone-series, benzotriazole-series, substituted acrylonitrile-series, nickel chelate-series, and hindered amine-series ultraviolet absorbers.

The above-described thermal transferable protective layer can be formed by adding necessary additives to a binder for the peeling layer, and dissolving the resultant binder mixture in an organic solvent or dispersing the same in an organic solvent or water to prepare dispersions, and thereafter coating the resultant dispersions on a support film using known film coat-forming methods, such as a gravure coat, gravure reverse coat and a roll coat. The protective layer may be formed in an arbitrary thickness, but a thickness after drying is preferably in a range of from 0.1 μm to 50 μm, more preferably from 1 μm to 10 μm.

### (Releasing Layer)

In the thermal transferable protective layer in the present invention, a releasing layer can be formed between a substrate sheet and a peeling layer so that the protective layer can be easily stripped off from the substrate sheet at the time when the protective layer is transferred by heat. In other words, the substrate sheet may be release processed by applying a release layer thereon. The release layer may be formed by coating and drying a coating liquid containing at least one of waxes, silicone waxes, silicone resins, fluorine resins, acrylic resins, polyvinyl alcohol resins, cellulose derivatives resins, urethane-series resins, acetic acid-series vinyl resins, acryl vinyl ether-series resins, maleic acid anhydride resins, and copolymers of these resins, using a conventionally known coating method, such as gravure coat and gravure reverse coat. Of these resins, preferred are polyvinyl alcohol resins and cellulose derivative resins. These resins are excellent in adhesion properties onto the substrate sheet and releasing properties from the peeling layer.

The releasing layer can be properly selected from, for example, a releasing layer that is designed to remain at the side of substrate sheet and a release layer of a deaggregating type. In the present invention, it is preferred from the viewpoint of excellence in a surface glossiness and a transfer stability of the peeling layer or the like, that the releasing layer is non-transferable and remains at the side of substrate sheet so that an interface between the releasing layer and the thermal transferable protective layer becomes a surface of the peeling layer after thermal transfer. The releasing layer can be formed by conventionally known coating methods. A thickness of the releasing layer under a dry condition is preferably in a range of from about 0.2 μm to about 5 μm, more preferably from about 0.2 μm to about 2 μm.

### (Adhesion Layer)

In the present invention, it is preferred that an adhesion layer be disposed on the outermost surface of the peeling layer of the thermal transferable protective layer, in order to improve adhesiveness of the protective layer to the transferee. For the adhesion layer, use can be made of general adhesives and heat-sensitive adhesives. It is more preferred to form an adhesion layer using a thermoplastic resin having a glass transition temperature of 50° C. to 80° C. Specifically, it is preferred to select resins having a suitable glass transition temperature from resins that exhibits excellent adhesiveness when heated, such as ultraviolet absorbing resins, acrylic resins, vinyl chloride-vinyl acetate copolymer resins, epoxy resins, polyester resins, polycarbonate resins, butyral resins, polyamide resins, and polyvinyl chloride resins.

To the adhesion layer, the followings may be added: the above-described resins and additives including organic ultraviolet absorbing agents such as benzophenone-series compounds, benzotriazole-series compounds, oxalic anilide-series compounds, cyanoacrylate-series compounds, and salicylate-series compounds, and inorganic fine particles having ultraviolet absorbing capacity (for example, oxides of metal such as zinc, titanium, cerium, tin, and iron). Further, it is optional to add other additives such as coloring pigments, white pigments, extender pigments, fillers, antistatic agents, antioxidants, and fluorescent whitening agents in accordance with necessity. The adhesion layer is formed by coating and then drying a coating liquid containing the above-described resin for construction of the adhesion layer, and the above-described additives that are optionally added to the adhesion layer, so that a thickness of the adhesion layer preferably becomes a range of from 0.5 μm to about 10 μm at the dry state.

As a support of the heat-sensitive transfer sheet, use can be made of the conventionally known support as that of the heat-sensitive transfer image-receiving sheet, such as polyethyleneterephthalate.

A thickness of the above-described support is preferably in a range of from 1 μm to 10 μm, more preferably from 2 μm to 10 μm. With respect to the heat-sensitive transfer sheet, there is a detailed explanation in, for example, JP-A-11-105437. The description in paragraph Nos. 0017 to 0078 of JP-A-11-105437 is preferably incorporated by reference in the specification of the present application.

### <Plasma Treatment>

In the present invention, a support of the heat-sensitive transfer sheet has been subjected to an atmospheric pressure plasma treatment (plasma processing).

The atmospheric (ordinary) pressure plasma treatment is a treatment that is performed by applying electric field to a gas such as nitrogen using a high frequency wave in an atmospheric pressure to cause ionization of the gas and to activate the gas to a discharge plasma state, and thereafter making the plasma-activated gas particles collide against a substrate surface to decompose molecular bonds on the substrate surface so that a hydroxyl group and the like can be formed on the substrate surface. Thereby the substrate surface is made hydrophilic, and/or molecular level irregularities are given to the substrate surface. By subjecting this treatment to the ink sheet substrate, the present invention enables to improve wetting properties of the substrate (adhesiveness of the surface), thereby to reduce irregular transfer of the thermal transferable protective layer.

In the above-described atmospheric pressure plasma treatment, it is possible to use basically any gases such as air, nitrogen, and oxygen. In the present invention, it is preferred to use a mixture of at least two kinds of gases, more preferably a mixture of substantially two kinds of gases. The term “substantially” herein used means that the mixture contains no other gases having a content of 1% or more, preferably 0.5% or more, and further preferably 0.1% or more.

In the present invention, preferred is a method of using nitrogen gas for the treatment. More preferred is a method of treating with a mixed gas in which oxygen gas is mixed in a content of from about 1% to about 10% based on nitrogen gas. In this case, it is more preferred to use both nitrogen gas and oxygen gas each having a high purity of 99.99% or more.

As a method for the atmospheric pressure plasma treatment, there are a method of subjecting a substrate surface directly to a plasma treatment by passing through the substrate into a discharge space and a method of plasma treating a substrate surface by spraying activated species onto the substrate surface from a discharge space. From the viewpoint that a surface treatment of the substrate is uniformly performed, it is preferred to employ the former treating method.

A frequency of the current source for use in plasma discharge varies depending on a quality of the material to be treated and a thickness thereof. However, a frequency ranging from 1,000 Hz to 50,000 Hz is preferably used in the present invention. It is more preferred to use a frequency ranging from 5,000 Hz to 40,000 Hz.

First, the heat-sensitive transfer image-receiving sheet of the present invention is explained.

### <Heat-Sensitive Transfer Image-Receiving Sheet>

The heat-sensitive transfer image-receiving sheet of the present invention (hereinafter also referred to as an image-receiving sheet) is provided with at least one dye-receiving layer (receptor layer) on a support. It is preferable to form an undercoat layer between the receptor layer and the support. As the undercoat layer, for example, a white background control layer, a charge control layer, an adhesion layer and a primer layer can be formed. Also, the heat insulation layer is preferably formed between the undercoat layer and the support. It is preferable that a curling control layer, a writing layer, or a charge-control layer be formed on the backside of the support. Each of these layers is applied using a usual method such as a roll coating, a bar coating, a gravure coating, a gravure reverse coating, a dye coating, a slide coating and a curtain coating. In practicing the present invention, a method capable of conducting a simultaneous multi-layer coating, such as the slide coating and the curtain coating, is preferable.

### (Receptor Layer)

The receptor layer performs functions of receiving dyes transferred from an ink sheet and retaining images formed. The image-receiving sheet of the present invention has at least one receptor layer preferably containing at least one thermoplastic receiving polymer that can receive the dyes. Further, receptor layer contains paraffin wax dispersion.

In the present invention, the receiving polymer is preferably used, as it is dispersed in a water-soluble dispersion medium as a latex polymer. In addition, the receptor layer preferably contains a water-soluble polymer together with the latex polymer. Co-presence of the latex polymer and the water-soluble polymer allows presence of the water-soluble polymer, which is hardly dyable, among the latex polymers and prevents diffusion of the dye fixed on the latex polymer, and consequently, reduces changes in the color sharpness of the receptor layer with the lapse of time and forms a recorded image smaller in changes for its transferred image quality with the lapse of time.

The receptor layer may contain, in addition to the latex polymer of the receiving polymer, another latex polymer having a different function, for example, for the purpose of adjusting the elastic modulus of the film. The receptor layer may be a single layer or double or more multi-layers.

### <Latex Polymer>

The latex polymer (polymer latex) that can be used in the present invention is explained.

In the heat-sensitive transfer image-receiving sheet of the present invention, the latex polymer that can be used in the receptor layer is a dispersion in which a water-insoluble hydrophobic polymer is dispersed as fine particles in a water-soluble dispersion medium. As the latex polymer, several different kinds of latex polymer can be used in combination. As the latex polymer for use in the present invention, it is preferred to use at least one latex polymer containing at least a vinyl chloride monomer as a monomer unit, namely a repeating (recurring) unit derived from vinyl chloride.

The dispersed state may be one in which polymer is emulsified in a dispersion medium, one in which polymer underwent emulsion polymerization, one in which polymer underwent micelle dispersion, one in which polymer molecules partially have a hydrophilic structure and thus the molecular chains themselves are dispersed in a molecular state, or the like. Latex polymers are described in “Gosei Jushi Emulsion (Synthetic Resin Emulsion)”, compiled by Taira Okuda and Hiroshi Inagaki, issued by Kobunshi Kanko Kai (1978); “Gosei Latex no Oyo (Application of Synthetic Latex)”, compiled by Takaaki Sugimura, Yasuo Kataoka, Souichi Suzuki, and Keishi Kasahara, issued by Kobunshi Kanko Kai (1993); Soichi Muroi, “Gosei Latex no Kagaku (Chemistry of Synthetic Latex)”, issued by Kobunshi Kanko Kai (1970); Yoshiaki Miyosawa (supervisor) “Suisei Coating-Zairyo no Kaihatsu to Oyo (Development and Application of Aqueous Coating Material)”, issued by CMC Publishing Co., Ltd. (2004) and JP-A-64-538, and so forth. In the present invention, the average diameter of the dispersed particles is preferably in the range of approximately 1 to 50,000 nm, more preferably 5 to 1,000 nm.

The latex polymer for use in the present invention may be latex of the so-called core/shell type, other than ordinary latex polymer of a uniform structure. When using a core/shell type latex polymer, it is preferred in some cases that the core and the shell have different glass transition temperatures. The glass transition temperature (Tg) of the latex polymer that can be used in the present invention is preferably −30° C. to 100° C., more preferably 0° C. to 80° C., further more preferably 10° C. to 70° C., and especially preferably 15° C. to 60° C.

The glass transition temperature (Tg) is calculated according to the following Formula (a):

1/Tg=Σ(Xi/Tgi) Formula (a)

wherein, assuming that the polymer is a copolymer composed of n monomers from i=1 to i=n, Xi is a weight fraction of the i-th monomer (ΣXi=1) and Tgi is glass transition temperature (measured in absolute temperature) of a homopolymer formed from the i-th monomer. The symbol Σ means the sum of i=1 to i=n. The value of the glass transition temperature of a homopolymer formed from each monomer (Tgi) is adopted from J. Brandrup and E. H. Immergut, “Polymer Handbook, 3rd. Edition”, Wiley-Interscience (1989).

As preferable embodiments of a latex polymer containing a repeating unit derived from vinyl chloride used in the receptor layer in the present invention, use may be preferably made of a polyvinyl chloride, a copolymer comprising vinyl chloride monomer unit, such as a vinyl chloride/vinyl acetate copolymer and a vinyl chloride/acrylate copolymer. In case of the copolymer, the vinyl chloride unit in molar ratio is preferably in the range of from 50 mass % to 95 mass %. These polymers may be straight-chain, branched, or cross-linked polymers, the so-called homopolymers obtained by polymerizing single type of monomers, or copolymers obtained by polymerizing two or more types of monomers. In the case of the copolymers, these copolymers may be either random copolymers or block copolymers. The molecular weight of each of these polymers is preferably 5,000 to 1,000,000, and further preferably 10,000 to 500,000 in terms of number-average molecular weight. Polymers having excessively small molecular weight impart insufficient dynamic strength to the layer containing the latex, and polymers having excessively large molecular weight bring about poor filming ability, and therefore both cases are not preferable. Crosslinkable latex polymers are also preferably used.

The latex polymer containing a repeating unit derived from vinyl chloride that can be used in the present invention is commercially available, and polymers described below may be utilized. Examples thereof include G351 and G576 (trade names, manufactured by Nippon Zeon Co., Ltd.); VINYBLAN 240, VINYBLAN 270, VINYBLAN 277, VINYBLAN 375, VINYBLAN 386, VINYBLAN 609, VINYBLAN 550, VINYBLAN 601, VINYBLAN 602, VINYBLAN 630, VINYBLAN 660, VINYBLAN 671, VINYBLAN 683, VINYBLAN 680, VINYBLAN 680S, VINYBLAN 681N, VINYBLAN 685R, VINYBLAN 277, VINYBLAN 380, VINYBLAN 381, VINYBLAN 410, VINYBLAN 430, VINYBLAN 432, VINYBLAN 860, VINYBLAN 863, VINYBLAN 865, VINYBLAN 867, VINYBLAN 900, VINYBLAN 900GT, VINYBLAN 938 and VINYBLAN 950 (trade names, manufactured by Nissin Chemical Industry Co., Ltd.).

In the present invention, another latex polymer that can be used with the latex polymer containing a repeating unit derived from vinyl chloride (vinyl chloride-based latex) in combination, is not particularly limited, but hydrophobic polymers, such as acrylic-series polymers, polyesters, rubbers (e.g., SBR resins), polyurethanes, polyvinyl chlorides, polyvinyl acetates, polyvinylidene chlorides, and polyolefins, are preferably used. These polymers may be straight-chain, branched, or cross-linked polymers, the so-called homopolymers obtained by polymerizing single type of monomers, or copolymers obtained by polymerizing two or more types of monomers. In the case of the copolymers, these copolymers may be either random copolymers or block copolymers. The molecular mass of each of these polymers is preferably 5,000 to 1,000,000, and further preferably 10,000 to 500,000 in terms of number average molecular mass. A polymer having an excessively small molecular mass imparts insufficient dynamic strength to a layer containing a latex of the polymer, and a polymer having an excessively large molecular mass brings about poor film-forming ability. Crosslinkable latex polymers are also preferably used.

Examples of the acrylic-series polymers include Cevian A-4635, 4718, and 4601 (trade names, manufactured by Daicel Chemical Industries); Nipol Lx811, 814, 821, 820, 855 (P-17: Tg 36° C.), and 857×2 (P-18: Tg 43° C.) (trade names, manufactured by Nippon Zeon Co., Ltd.); Voncoat R3370 (P-19: Tg 25° C.), and 4280 (P-20: Tg 15° C.) (trade names, manufactured by Dai-Nippon Ink & Chemicals, Inc.); Julimer ET-410 (P-21: Tg 44° C.) (trade name, manufactured by Nihon Junyaku K.K.); AE116 (P-22: Tg 50° C.), AE119 (P-23: Tg 55° C.), AE121 (P-24: Tg 58° C.), AE125 (P-25: Tg 60° C.), AE134 (P-26: Tg 48° C.), AE137 (P-27: Tg 48° C.), AE140 (P-28: Tg 53° C.), and AE173 (P-29: Tg 60° C.) (trade names, manufactured by JSR Corporation); Aron A-104 (P-30: Tg 45° C.) (trade name, manufactured by Toagosei Co., Ltd.); NS-600X, and NS-620X (trade names, manufactured by Takamatsu Yushi K.K.); VINYBLAN 2580, 2583, 2641, 2770, 2770H, 2635, 2886, 5202C, and 2706 (trade names, manufactured by Nissin Chemical Industry Co., Ltd.).

Examples of the polyesters include FINETEX ES650, 611, 675, and 850 (trade names, manufactured by Dainippon Ink and Chemicals, Incorporated); WD-size, and WMS (trade names, manufactured by Eastman Chemical Ltd.); A-110, A-115GE, A-120, A-121, A-124GP, A-124S, A-160P, A-210, A-215GE, A-510, A-513E, A-515GE, A-520, A-610, A-613, A-615GE, A-620, WAC-10, WAC-15, WAC-17XC, WAC-20, S-110, S-110EA, S-111SL, S-120, S-140, S-140A, S-250, S-252G, S-250S, S-320, S-680, DNS-63P, NS-122L, NS-122LX, NS-244LX, NS-140L, NS-141LX, and NS-282LX (trade names, manufactured by Takamatsu Yushi K.K.); Aronmelt PES-1000 series, and PES-2000 series (trade names, manufactured by Toagosei Co., Ltd.); Bironal MD-1100, MD-1200, MD-1220, MD-1245, MD-1250, MD-1335, MD-1400, MD-1480, MD-1500, MD-1930, and MD-1985 (trade names, manufactured by Toyobo Co., Ltd.); and Ceporjon ES (trade name, manufactured by Sumitomo Seika Chemicals Co., Ltd.).

Examples of the polyurethanes include HYDRAN AP10, AP20, AP30, AP40, and 101H, Vondic 1320NS and 1610NS (trade names, manufactured by Dainippon Ink and Chemicals, Incorporated); D-1000, D-2000, D-6000, D-4000, and D-9000 (trade names, manufactured by Dainichi Seika Color & Chemicals Mfg. Co., Ltd.); NS-155X, NS-310A, NS-310X, and NS-311X (trade names, manufactured by Takamatsu Yushi K.K.); and Elastron (trade name, manufactured by Dai-ichi Kogyo Seiyaku Co., Ltd.).

Examples of the rubbers include LACSTAR 7310K, 3307B, 4700H, and 7132C (trade names, manufactured by Dainippon Ink & Chemicals Incorporated); and Nipol Lx416, LX410, LX430, LX435, LX110, LX415A, LX438C, 2507H, LX303A, LX407BP series, V1004, and MH5055 (trade names, manufactured by Nippon Zeon Co., Ltd.).

Examples of the polyolefins include Chemipearl S120, SA100, and V300 (P-40: Tg 80° C.) (trade names, manufactured by Mitsui Petrochemical); Voncoat 2830, 2210, and 2960 (trade names, manufactured by Dainippon Ink and Chemicals, Incorporated); and Zaikusen and Ceporjon G (trade names, manufactured by Sumitomo Seika Chemicals Co., Ltd.).

Examples of the copolymer nylons include Ceporjon PA (trade name, manufactured by Sumitomo Seika Chemicals Co., Ltd.).

Examples of the polyvinyl acetates include VINYBLAN 1080, 1082, 1085W, 1108W, 1108S, 1563M, 1566, 1570, 1588C, A22J7-F2, 1128C, 1137, 1138, A20J2, A23J1, A23J1, A23K1, A23P2E, A68J1N, 1086A, 1086, 1086D, 1108S, 1187, 1241LT, 1580N, 1083, 1571, 1572, 1581, 4465, 4466, 4468W, 4468S, 4470, 4485LL, 4495LL, 1023, 1042, 1060, 1060S, 1080M, 1084W, 1084S, 1096, 1570K, 1050, 1050S, 3290, 1017AD, 1002, 1006, 1008, 1107L, 1225, 1245L, GV-6170, GV-6181, 4468W, and 4468S (trade names, manufactured by Nisshin Chemical Industry Co., Ltd.).

These latex polymers may be used singly, or two or more of these polymers may be blended, if necessary.

In the receptor layer for use in the present invention, a ratio of the latex polymer comprising a component of vinyl chloride is preferably 50 mol % to 99 mol %, more preferably 60 mol % to 98 mol %.

In the present invention, the glass transition temperature (Tg) of the latex polymer having the other structure that can be used in combination with the latex polymer comprising vinyl chloride as a monomer unit is preferably in the range of −30° C. to 70° C., more preferably −10° C. to 50° C., still more preferably 0° C. to 40° C., in view of film-forming properties (brittleness for working) and image preservability. A blend of two or more types of polymers can be used as the binder. When a blend of two or more polymers is used, the average Tg obtained by summing up the Tg of each polymer weighted by its proportion, is preferably within the foregoing range. Also, when phase separation occurs or when a core-shell structure is adopted, the weighted average Tg is preferably within the foregoing range.

In the present invention, it is preferable to prepare the latex polymer by applying an aqueous type coating solution and then drying it. The “aqueous type” so-called here means that 60% by mass or more of the solvent (dispersion medium) of the coating solution is water. As a component other than water in the coating solution, a water miscible organic solvent may be used, such as methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethylene glycol monoethyl ether, and oxyethyl phenyl ether.

The latex polymer in the image-receiving sheet used in the present invention includes a state of a gel or dried film formed by removing a part of solvents by drying after coating.

### (Releasing Agent)

The receptor layer preferably contains paraffin wax dispersions as a releasing agent. The paraffin wax belongs to a petroleum wax and can be produced by separating and refining hydrocarbons with a good crystallinity from distillate oil obtained by distillation under a reduced pressure in a petroleum processing. The petroleum wax is classified into three kinds of waxes, namely petroleum wax, microcrystalline wax and petrolatum according to JISK 2235. The microcrystalline wax that can be produced in the same manner as the above-described method has a molecular weight ranging from 500 to 800 and about 30 to 60 carbon atoms. Main components of the microcrystalline wax are branched hydrocarbons (isoparaffin) in which a large main chain has a side chain and cyclic hydrocarbons (cycloparaffin). On the other hand, the paraffin wax has a molecular weight ranging from 300 to 550 that is shorter than the microcrystalline wax. Straight chain hydrocarbons are a main component and the carbon number ranges from about 20 to about 40. Therefore, it is supposed that a melting point distribution of the paraffin wax would be narrower than the microcrystalline wax.

Examples of the paraffin wax include articles sold on the market, such as paraffin waxes 115, 120, 125, 130, 135, 140, 145, 150, 155, HNP-3, HNP-5, HNP-9, HNP-10, HNP-11, HNP-12, SP-0165, SP-0160, SP-0145, SP-1040, SP-1035, SP-3040, SP-3035, EMW-0001, and EMW-0003, each of which is a trade name, and a product of NIPPON SEIRO.

In the present invention, it is considered that an effect of the paraffin wax dispersions as a releasing agent is exhibited by a high thermal energy at a high density area, and consequently coexistence of the releasing property and a protective layer transfer property under the condition of low thermal energy at the time of the protective layer transfer can be accomplished.

In the receptor layer, for prevention from heat seal with a heat-sensitive transfer sheet (i.e. an ink sheet) at the time of image formation, the aforementioned high-molecular releasing agent may be blended with another compound(s) as an auxiliary releasing agent. As the releasing agent, use may be made of any of silicone oil, phosphoric acid ester-series plasticizers, and fluorine compounds. Silicone oil is preferably used in particular. As the silicone oil, use may be preferably made of various modified silicone oil, such as those modified with any groups of epoxy, alkyl, amino, carboxyl, alcohol, fluorine, alkyl aralkyl polyether, epoxy polyether, or polyether. Of these modified silicone oils, it is preferred to use a reaction product of a vinyl modified silicone oil with a hydrogen modified silicone oil.

As the silicone oil as the releasing agent, straight silicone oil and modified silicone oil or their hardened products may be used.

Examples of the straight silicone oil include dimethylsilicone oil, methylphenylsilicone oil and methyl hydrogen silicone oil. Examples of the dimethylsilicone oil include KF96-10, KF96-100, KF96-1000, KF96H-10000, KF96H-12500 and KF96H-100000 (all of these names are trade names, manufactured by Shin-Etsu Chemical Co., Ltd.). Examples of the methylphenylsilicone oil include KF50-100, KF54 and KF56 (all of these names are trade names, manufactured by Shin-Etsu Chemical Co., Ltd.).

The modified silicone oil may be classified into reactive silicone oils and non-reactive silicone oils. Examples of the reactive silicone oils include amino-modified, epoxy-modified, carboxyl-modified, hydroxy-modified, methacryl-modified, mercapto-modified, phenol-modified or one-terminal reactive/hetero-functional group-modified silicone oils. Examples of the amino-modified silicone oil include KF-393, KF-857, KF-858, X-22-3680, X-22-3801C, KF-8010, X-22-161A and KF-8012 (all of these names are trade names, manufactured by Shin-Etsu Chemical Co., Ltd.). Examples of the epoxy-modified silicone oil include KF-100T, KF-101, KF-60-164, KF-103, X-22-343 and X-22-3000T (all of these names are trade names, manufactured by Shin-Etsu Chemical Co., Ltd.). Examples of the carboxyl-modified silicone oil include X-22-162C (trade name, manufactured by Shin-Etsu Chemical Co., Ltd.). Examples of the hydroxy-modified silicone oil include X-22-160AS, KF-6001, KF-6002, KF-6003, X-22-170DX, X-22-176DX, X-22-176D and X-22-176DF (all of these names are trade names, manufactured by Shin-Etsu Chemical Co., Ltd.). Examples of the methacryl-modified silicone oil include X-22-164A, X-22-164C, X-24-8201, X-22-174D and X-22-2426 (all of these names are trade names, manufactured by Shin-Etsu Chemical Co., Ltd.).

Reactive silicone oils may be hardened upon use, and may be classified into a reaction-curable type, photocurable type, catalyst-curable type, and the like. Among these types, silicone oil that is the reaction-curable type is particularly preferable. As the reaction-curable type silicone oil, products obtained by reacting an amino-modified silicone oil with an epoxy-modified silicone oil and then by curing are preferable. Also, examples of the catalyst-curable type or photocurable type silicone oil include KS-705F-PS, KS-705F-PS-1 and KS-770-PL-3 (all of these names are trade names, catalyst-curable silicone oils, manufactured by Shin-Etsu Chemical Co., Ltd.) and KS-720 and KS-774-PL-3 (all of these names are trade names, photocurable silicone oils, manufactured by Shin-Etsu Chemical Co., Ltd.). The addition amount of the curable type silicone oil is preferably 0.5 to 30% by mass based on the resin constituting the receptor layer. The releasing agent is used preferably in an amount of 2 to 4% by mass and further preferably 2 to 3% by mass based on 100 parts by mass of the polyester resin. If the amount is too small, the releasability cannot be secured without fail, whereas if the amount is excessive, a protective layer is not transferred to the image-receiving sheet resultantly.

Examples of the non-reactive silicone oil include polyether-modified, methylstyryl-modified, alkyl-modified, higher fatty acid ester-modified, hydrophilic special-modified, higher alkoxy-modified or fluorine-modified silicone oils. Examples of the polyether-modified silicone oil include KF-6012 (trade name, manufactured by Shin-Etsu Chemical Co., Ltd.) and examples of the methylstyryl-modified silicone oil include 24-510 and KF41-410 (all of these names are trade names, manufactured by Shin-Etsu Chemical Co., Ltd.). Modified silicones represented by any one of the following Formulae 1 to 3 may also be used.

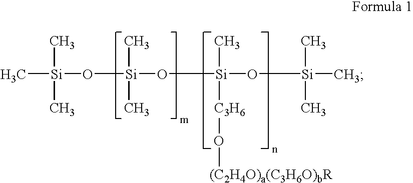

In the Formula 1, R represents a hydrogen atom or a straight-chain or branched alkyl group which may be substituted with an aryl or cycloalkyl group. m and n respectively denote an integer of 2,000 or less, and a and b respectively denote an integer of 30 or less.

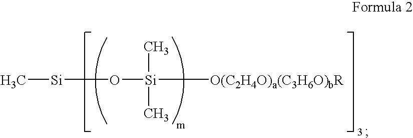

In the Formula 2, R represents a hydrogen atom or a straight-chain or branched alkyl group which may be substituted with an aryl or cycloalkyl group. m denotes an integer of 2,000 or less, and a and b respectively denote an integer of 30 or less.

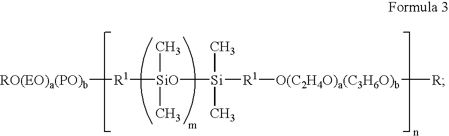

In the Formula 3, R represents a hydrogen atom or a straight-chain or branched alkyl group which may be substituted with an aryl or cycloalkyl group. m and n respectively denote an integer of 2,000 or less, and a and b respectively denote an integer of 30 or less. R¹ represents a single bond or a divalent linking group, E represents an ethylene group which may be further substituted, and P represents a propylene group which may be further substituted.

Silicone oils such as those mentioned above are described in “SILICONE HANDBOOK” (The Nikkan Kogyo Shimbun, Ltd.) and the technologies described in each publication of JP-A-8-108636 and JP-A-2002-264543 may be preferably used as the technologies to cure the curable type silicone oils.

In the present invention, a melting point (melting temperature) of a base wax in the paraffin wax dispersions is preferably 60° C. or more, but less than 100° C., and more preferably 70° C. or more, but less than 100° C. The melting point can be determined by measurement according to JIS K2235-5.3.2. The wax is preferably in a state of being dispersed in water, more preferably in the form of fine particles. Dispersing waxes in water and forming waxes into fine particles can be performed using the methods as described in “Kaitei Wax no Seishitsu to Oyo (Revised version, Properties and Applications of Wax)”, Saiwai Shobo (1989).

An addition amount of the wax is preferably from 0.5% to 30% by mass, more preferably from 1% to 20% by mass and further more preferably from 1.5% to 15% by mass, of the amount of total solid content in the receptor layer respectively.

The paraffin wax dispersions may be used supplementarily together with any other waxes. However, in order to preferably achieve the effects of the present invention, it is necessary that a ratio of the paraffin wax dispersions to the total addition amount of waxes be controlled to the range of from 50% by mass to 100% by mass.

### (Water-Soluble Polymer)

The receptor layer preferably contains a water-soluble polymer. Herein, the water-soluble polymer is described below.

Herein, “water-soluble polymer” means a polymer which dissolves, in 100 g water at 20° C., in an amount of preferably 0.05 g or more, more preferably 0.1 g or more, further preferably 0.5 g or more, and particularly preferably 1 g or more.

Further, the latex polymer formed by dispersing polymer fine particles by a dispersion medium is different from the water-soluble polymer which can be used in the present invention. The water-soluble polymer which can be used in the present invention is natural polymers (polysaccharide type, microorganism type, and animal type), semi-synthetic polymers (cellulose-based, starch-based, and alginic acid-based), and synthetic polymer type (vinyl type and others); and synthetic polymers including polyvinyl alcohols, and natural or semi-synthetic polymers using celluloses derived from plant as starting materials, which will be explained later, correspond to the water-soluble polymer usable in the present invention.

Among the water-soluble polymers which can be used in the present invention, the natural polymers and the semi-synthetic polymers will be explained in detail. Specific examples include the following polymers: plant type polysaccharides such as gum arabics, κ-carrageenans, τ-carrageenans, λ-carrageenans, guar gums (e.g. Supercol, manufactured by Squalon), locust bean gums, pectins, tragacanths, and corn starches (e.g. Purity-21, manufactured by National Starch & Chemical Co.); microbial type polysaccharides such as xanthan gums (e.g. Keltrol T, manufactured by Kelco) and dextrins (e.g. Nadex 360, manufactured by National Starch & Chemical Co.); animal type natural polymers such as gelatins (e.g. Crodyne B419, manufactured by Croda), caseins, sodium chondroitin sulfates (e.g. Cromoist CS, manufactured by Croda); cellulose-based polymers such as ethylcelluloses (e.g. Cellofas WLD, manufactured by I.C.I.), carboxymethylcelluloses (e.g. CMC, manufactured by Daicel), hydroxyethylcelluloses (e.g. HEC, manufactured by Daicel), hydroxypropylcelluloses (e.g. Klucel, manufactured by Aqualon), methylcelluloses (e.g. Viscontran, manufactured by Henkel), nitrocelluloses (e.g. Isopropyl Wet, manufactured by Hercules), and cationated celluloses (e.g. Crodacel QM, manufactured by Croda); starches such as phosphorylated starches (e.g. National 78-1898, manufactured by National Starch & Chemical Co.); alginic acid-based compounds such as sodium alginates (e.g. Keltone, manufactured by Kelco) and propylene glycol alginates; and other polymers such as cationated guar gums (e.g. Hi-care 1000, manufactured by Alcolac) and sodium hyaluronates (e.g. Hyalure, manufactured by Lifecare Biomedial) (all of the names are trade names).

Gelatin is one of preferable embodiments in the present invention. Gelatin having a molecular weight of from 10,000 to 1,000,000 may be used in the present invention. Gelatin that can be used in the present invention may contain an anion such as Cl⁻ and SO₄²⁻, or alternatively a cation such as Fe²⁺, Ca²⁺, Mg²⁺, Sn²⁺, and Zn²⁺. Gelatin is preferably added as an aqueous solution.

Among the water-soluble polymers which can be used in the present invention, the synthetic polymers will be explained in detail. Examples of the acryl type include sodium polyacrylates, polyacrylic acid copolymers, polyacrylamides, polyacrylamide copolymers, and polydiethylaminoethyl(meth)acrylate quaternary salts or their copolymers. Examples of the vinyl type include polyvinylpyrrolidones, polyvinylpyrrolidone copolymers, and polyvinyl alcohols. Examples of the others include polyethylene glycols, polypropylene glycols, polyisopropylacrylamides, polymethyl vinyl ethers, polyethyleneimines, polystyrenesulfonic acids or their copolymers, naphthalenesulfonic acid condensate salts, polyvinylsulfonic acids or their copolymers, polyacrylic acids or their copolymers, acrylic acid or its copolymers, maleic acid copolymers, maleic acid monoester copolymers, acryloylmethylpropanesulfonic acid or its copolymers, polydimethyldiallylammonium chlorides or their copolymers, polyamidines or their copolymers, polyimidazolines, dicyanamide type condensates, epichlorohydrin/dimethylamine condensates, Hofmann decomposed products of polyacrylamides, and water-soluble polyesters (Plascoat Z-221, Z-446, Z-561, Z-450, Z-565, Z-850, Z-3308, RZ-105, RZ-570, Z-730 and RX-142 (all of these names are trade names), manufactured by Goo Chemical Co., Ltd.).

In addition, highly-water-absorptive polymers, namely, homopolymers of vinyl monomers having —COOM or —SO₃M (M represents a hydrogen atom or an alkali metal atom) or copolymers of these vinyl monomers among them or with other vinyl monomers (for example, sodium methacrylate, ammonium methacrylate, Sumikagel L-5H (trade name) manufactured by Sumitomo Chemical Co., Ltd.) as described in, for example, U.S. Pat. No. 4,960,681 and JP-A-62-245260, may also be used.

Among the water-soluble synthetic polymers that can be used in the present invention, polyvinyl alcohols are preferable. The polyvinyl alcohols are explained in detail below.

Examples of completely saponificated polyvinyl alcohol include PVA-105 [polyvinyl alcohol (PVA) content: 94.0 mass % or more; degree of saponification: 98.5±0.5 mol %; content of sodium acetate: 1.5 mass % or less; volatile constituent: 5.0 mass % or less; viscosity (4 mass %; 20° C.): 5.6±0.4 CPS]; PVA-110 [PVA content: 94.0 mass %; degree of saponification: 98.5±0.5 mol %; content of sodium acetate: 1.5 mass %; volatile constituent: 5.0 mass %; viscosity (4 mass %; 20° C.): 11.0±0.8 CPS]; PVA-117 [PVA content: 94.0 mass %; degree of saponification: 98.5±0.5 mol %; content of sodium acetate: 1.0 mass %; volatile constituent: 5.0 mass %; viscosity (4 mass %; 20° C.): 28.0±3.0 CPS]; PVA-117H [PVA content: 93.5 mass %; degree of saponification: 99.6±0.3 mol %; content of sodium acetate: 1.85 mass %; volatile constituent: 5.0 mass %; viscosity (4 mass %; 20° C.): 29.0±3.0 CPS]; PVA-120 [PVA content: 94.0 mass %; degree of saponification: 98.5±0.5 mol %; content of sodium acetate: 1.0 mass %; volatile constituent: 5.0 mass %; viscosity (4 mass %; 20° C.): 39.5±4.5 CPS]; PVA-124 [PVA content: 94.0 mass %; degree of saponification: 98.5±0.5 mol %; content of sodium acetate: 1.0 mass %; volatile constituent: 5.0 mass %; viscosity (4 mass %; 20° C.): 60.0±6.0 CPS]; PVA-124H [PVA content: 93.5 mass %; degree of saponification: 99.6±0.3 mol %; content of sodium acetate: 1.85 mass %; volatile constituent: 5.0 mass %; viscosity (4 mass %; 20° C.): 61.0±6.0 CPS]; PVA-CS [PVA content: 94.0 mass %; degree of saponification: 97.5±0.5 mol %; content of sodium acetate: 1.0 mass %; volatile constituent: 5.0 mass %; viscosity (4 mass %; 20° C.): 27.5±3.0 CPS]; PVA-CST [PVA content: 94.0 mass %; degree of saponification: 96.0±0.5 mol %; content of sodium acetate: 1.0 mass %; volatile constituent: 5.0 mass %; viscosity (4 mass %; 20° C.): 27.0±3.0 CPS]; and PVA-HC [PVA content: 90.0 mass %; degree of saponification: 99.85 mol % or more; content of sodium acetate: 2.5 mass %; volatile constituent: 8.5 mass %; viscosity (4 mass %; 20° C.): 25.0±3.5 CPS] (all trade names, manufactured by Kuraray Co., Ltd.), and the like.

Examples of partially saponificated polyvinyl alcohol include PVA-203 [PVA content: 94.0 mass %; degree of saponification: 88.0±1.5 mol %; content of sodium acetate: 1.0 mass %; volatile constituent: 5.0 mass %; viscosity (4 mass %; 20° C.): 3.4±0.2 CPS]; PVA-204 [PVA content: 94.0 mass %; degree of saponification: 88.0±1.5 mol %; content of sodium acetate: 1.0 mass %; volatile constituent: 5.0 mass %; viscosity (4 mass %; 20° C.): 3.9±0.3 CPS]; PVA-205 [PVA content: 94.0 mass %; degree of saponification: 88.0±1.5 mol %; content of sodium acetate: 1.0 mass %; volatile constituent: 5.0 mass %; viscosity (4 mass %; 20° C.): 5.0±0.4 CPS]; PVA-210 [PVA content: 94.0 mass %; degree of saponification: 88.0±1.0 mol %; content of sodium acetate: 1.0 mass %; volatile constituent: 5.0 mass %; viscosity (4 mass %; 20° C.): 9.0±1.0 CPS]; PVA-217 [PVA content: 94.0 mass %; degree of saponification: 88.0±1.0 mol %; content of sodium acetate: 1.0 mass %; volatile constituent: 5.0 mass %; viscosity (4 mass %; 20° C.): 22.5±2.0 CPS]; PVA-220 [PVA content: 94.0 mass %; degree of saponification: 88.0±1.0 mol %; content of sodium acetate: 1.0 mass %; volatile constituent: 5.0 mass %; viscosity (4 mass %; 20° C.): 30.0±3.0 CPS]; PVA-224 [PVA content: 94.0 mass %; degree of saponification: 88.0±1.5 mol %; content of sodium acetate: 1.0 mass %; volatile constituent: 5.0 mass %; viscosity (4 mass %; 20° C.): 44.0±4.0 CPS]; PVA-228 [PVA content: 94.0 mass %; degree of saponification: 88.0±1.5 mol %; content of sodium acetate: 1.0 mass %; volatile constituent: 5.0 mass %; viscosity (4 mass %; 20° C.): 65.0±5.0 CPS]; PVA-235 [PVA content: 94.0 mass %; degree of saponification: 88.0±1.5 mol %; content of sodium acetate: 1.0 mass %; volatile constituent: 5.0 mass %; viscosity (4 mass %; 20° C.): 95.0±15.0 CPS]; PVA-217EE [PVA content: 94.0 mass %; degree of saponification: 88.0±1.0 mol %; content of sodium acetate: 1.0 mass %; volatile constituent: 5.0 mass %; viscosity (4 mass %; 20° C.): 23.0±3.0 CPS]; PVA-217E [PVA content: 94.0 mass %; degree of saponification: 88.0±1.0 mol %; content of sodium acetate: 1.0 mass %; volatile constituent: 5.0 mass %; viscosity (4 mass %; 20° C.): 23.0±3.0 CPS]; PVA-220E [PVA content: 94.0 mass %; degree of saponification: 88.0±1.0 mol %; content of sodium acetate: 1.0 mass %; volatile constituent: 5.0 mass %; viscosity (4 mass %; 20° C.): 31.0±4.0 CPS]; PVA-224E [PVA content: 94.0 mass %; degree of saponification: 88.0±1.0 mol %; content of sodium acetate: 1.0 mass %; volatile constituent: 5.0 mass %; viscosity (4 mass %; 20° C.): 45.0±5.0 CPS]; PVA-403 [PVA content: 94.0 mass %; degree of saponification: 80.0±1.5 mol %; content of sodium acetate: 1.0 mass %; volatile constituent: 5.0 mass %; viscosity (4 mass %; 20° C.): 3.1±0.3 CPS]; PVA-405 [PVA content: 94.0 mass %; degree of saponification: 81.5±1.5 mol %; content of sodium acetate: 1.0 mass %; volatile constituent: 5.0 mass %; viscosity (4 mass %; 20° C.): 4.8±0.4 CPS]; PVA-420 [PVA content: 94.0 mass %; degree of saponification: 79.5±1.5 mol %; content of sodium acetate: 1.0 mass %; volatile constituent: 5.0 mass %]; PVA-613 [PVA content: 94.0 mass %; degree of saponification: 93.5±1.0 mol %; content of sodium acetate: 1.0 mass %; volatile constituent: 5.0 mass %; viscosity (4 mass %; 20° C.): 16.5±2.0 CPS]; and L-8 [PVA content: 96.0 mass %; degree of saponification: 71.0±1.5 mol %; content of sodium acetate: 1.0 mass % (ash); volatile constituent: 3.0 mass %; viscosity (4 mass %; 20° C.): 5.4±0.4 CPS] (all trade names, manufactured by Kuraray Co., Ltd.), and the like.

The above values were measured in the manner described in JIS K-6726-1977.

With respect to modified polyvinyl alcohols, those described in Koichi Nagano, et al., “Poval”, Kobunshi Kankokai, Inc. are useful. The modified polyvinyl alcohols include polyvinyl alcohols modified by cations, anions, —SH compounds, alkylthio compounds, or silanols.

Examples of such modified polyvinyl alcohols (modified PVA) include C polymers such as C-118, C-318, C-318-2A, and C-506 (all being trade names of Kuraray Co., Ltd.); HL polymers such as HL-12E and HL-1203 (all being trade names of Kuraray Co., Ltd.); HM polymers such as HM-03 and HM-N-03 (all being trade names of Kuraray Co., Ltd.); K polymers such as KL-118, KL-318, KL-506, KM-118T, and KM-618 (all being trade names of Kuraray Co., Ltd.); M polymers such as M-115 (a trade name of Kuraray co., Ltd.); MP polymers such as MP-102, MP-202, and MP-203 (all being trade names of Kuraray Co., Ltd.); MPK polymers such as MPK-1, MPK-2, MPK-3, MPK-4, MPK-5, and MPK-6 (all being trade names of Kuraray Co., Ltd.); R polymers such as R-1130, R-2105, and R-2130 (all being trade names of Kuraray Co., Ltd.); and V polymers such as V-2250 (a trade name of Kuraray Co., Ltd.).

The viscosity of polyvinyl alcohol can be adjusted or stabilized by adding a trace amount of a solvent or an inorganic salt to an aqueous solution of polyvinyl alcohol, and there can be employed compounds described in the aforementioned reference “Poval”, Koichi Nagano et al., published by Kobunshi Kankokai, pp. 144-154. For example, a coated-surface quality can be improved by an addition of boric acid, and the addition of boric acid is preferable. The amount of boric acid added is preferably 0.01 to 40 mass % with respect to polyvinyl alcohol.

Preferred binders are transparent or semitransparent, and generally colorless. Examples include natural resins, polymers and copolymers; synthetic resins, polymers, and copolymers; and other media that form films: for example, rubbers, polyvinyl alcohols, hydroxyethyl celluloses, cellulose acetates, cellulose acetate butylates, polyvinylpyrrolidones, starches, polyacrylic acids, polymethyl methacrylates, polyvinyl chlorides, polymethacrylic acids, styrene/maleic acid anhydride copolymers, styrene/acrylonitrile copolymers, styrene/butadiene copolymers, polyvinylacetals (e.g., polyvinylformals and polyvinylbutyrals), polyesters, polyurethanes, phenoxy resins, polyvinylidene chlorides, polyepoxides, polycarbonates, polyvinyl acetates, polyolefins, cellulose esters, and polyamides. These media are water-soluble.

In the present invention, preferred water-soluble polymers are polyvinyl alcohols and gelatin, with gelatin being most preferred.

The amount of the water-soluble polymer added to the receptor layer is preferably from 1 to 25% by mass, more preferably from 1 to 10% by mass based on the entire mass of the receptor layer.

### (Hardener)

As the cross-linking agent that can be used in the present invention, a hardener (hardening agent) may be added in coating layers (e.g., the receptor layer, the heat insulation layer, the undercoat layer) of the image-receiving sheet.

Preferable examples of the hardener that can be used in the present invention include H-1, 4, 6, 8, and 14 in JP-A-1-214845 in page 17; compounds (H-1 to H-54) represented by one of the formulae (VII) to (XII) in U.S. Pat. No. 4,618,573, columns 13 to 23; compounds (H-1 to H-76) represented by the formula (6) in JP-A-2-214852, page 8, the lower right (particularly, H-14); and compounds described in Claim 1 in U.S. Pat. No. 3,325,287. Examples of the hardening agent include hardening agents described, for example, in U.S. Pat. No. 4,678,739, column 41, U.S. Pat. No. 4,791,042, JP-A-59-116655, JP-A-62-245261, JP-A-61-18942, and JP-A-4-218044. More specifically, an aldehyde-series hardening agent (formaldehyde, etc.), an aziridine-series hardening agent, an epoxy-series hardening agent, a vinyl sulfone-series hardening agent (N,N′-ethylene-bis(vinylsulfonylacetamido)ethane, etc.), an N-methylol-series hardening agent (dimethylol urea, etc.), a boric acid, a metaboric acid, or a polymer hardening agent (compounds described, for example, in JP-A-62-234157), can be mentioned.

Preferable examples of the hardener include a vinylsulfone-series hardener and chlorotriazines.

More preferable hardeners in the present invention are compounds represented by the following Formula (B) or (C).

(CH₂═CH—SO₂)ₙ-L Formula (B)

(X—CH₂—CH₂—SO₂)ₙ-L Formula (C)

In formulae (B) and (C), X represents a halogen atom, L represents an organic linking group having n-valency. When the compound represented by formula (B) or (C) is a low-molecular compound, n denotes an integer from 1 to 4. When the compound represented by formula (B) or (C) is a high-molecular (polymer) compound, L represents an organic linking group containing a polymer chain and n denotes an integer ranging from 10 to 1,000.

In the Formulae (B) and (C), X is preferably a chlorine atom or a bromine atom, and further preferably a bromine atom. n is an integer from 1 to 4, preferably an integer from 2 to 4, more preferably 2 or 3 and most preferably 2.

L represents an organic group having n-valency, and preferably an aliphatic hydrocarbon group, an aromatic hydrocarbon group or a heterocyclic group, provided that these groups may be combined through an ether bond, ester bond, amide bond, sulfonamide bond, urea bond, urethane bond or the like. Also, each of these groups may be further substituted. Examples of the substituent include a halogen atom, alkyl group, aryl group, heterocyclic group, hydroxyl group, alkoxy group, aryloxy group, alkylthio group, arylthio group, acyloxy group, alkoxycarbonyl group, carbamoyloxy group, acyl group, acyloxy group, acylamino group, sulfonamide group, carbamoyl group, sulfamoyl group, sulfonyl group, phosphoryl group, carboxyl group and sulfo group. Among these groups, a halogen atom, alkyl group, hydroxy group, alkoxy group, aryloxy group and acyloxy group are preferable.

Specific examples of the vinylsulfone-series hardener include, though not limited to, the following compounds (VS-1) to (VS-27).

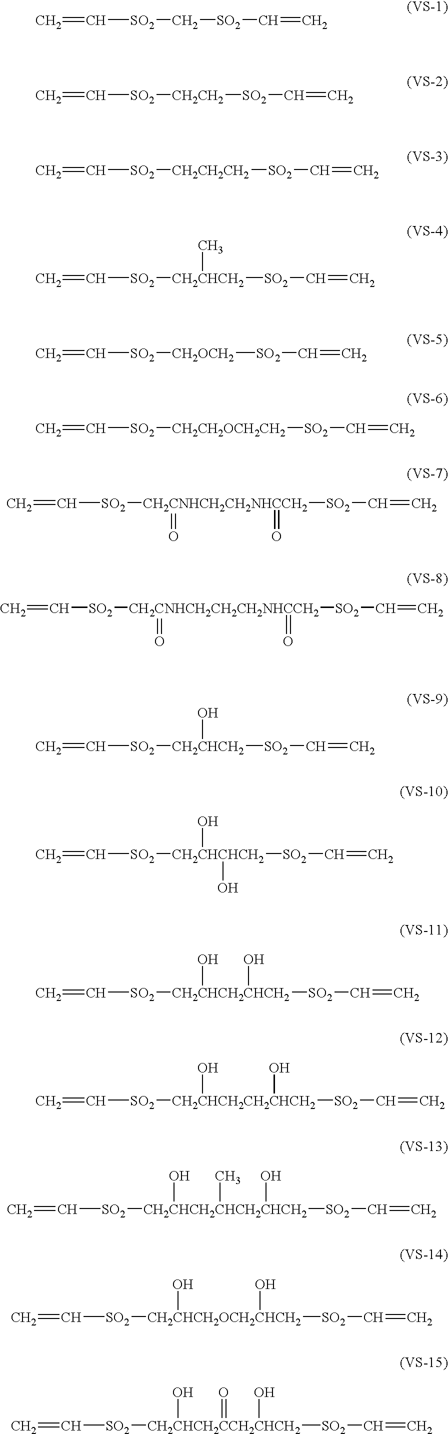

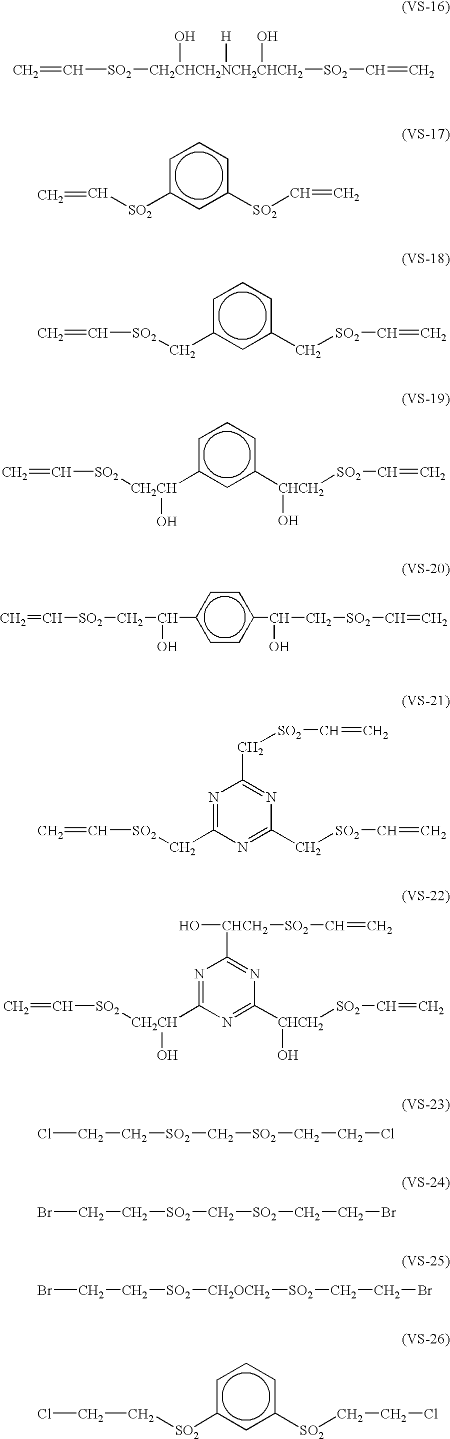

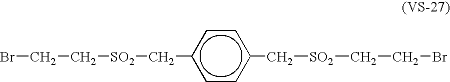

These hardeners may be obtained with reference to the method described in, for example, the specification of U.S. Pat. No. 4,173,481.

Furthermore, as the chlorotriazine-series hardener, a 1,3,5-triazine compound in which at least one of the 2-position, 4-position and 6-position of the triazine ring in the compound is substituted with a chlorine atom, is preferable. A 1,3,5-triazine compound in which two or three of the 2-position, 4-position and 6-position of the triazine ring each are substituted with a chlorine atom, is more preferable. Alternatively, use may be made of a 1,3,5-triazine compound in which at least one of the 2-position, 4-position and 6-position of the triazine ring is substituted with a chlorine atom, and the remainder position(s) is/are substituted with a group(s) or atom(s) other than a chlorine atom. Examples of these other groups include a hydrogen atom, bromine atom, fluorine atom, iodine atom, alkyl group, alkenyl group, alkynyl group, cycloalkyl group, cycloalkenyl group, aryl group, heterocyclic group, hydroxy group, nitro group, cyano group, amino group, hydroxylamino group, alkylamino group, arylamino group, heterocyclic amino group, acylamino group, sulfonamide group, carbamoyl group, sulfamoyl group, sulfo group, carboxyl group, alkoxy group, alkenoxy group, aryloxy group, heterocyclic oxy group, acyl group, acyloxy group, alkyl- or aryl-sulfonyl group, alkyl- or aryl-sulfinyl group, alkyl- or aryl-sulfonyloxy group, mercapto group, alkylthio group, alkenylthio group, arylthio group, heterocyclic thio group and alkyloxy- or aryloxy-carbonyl group.

Specific examples of the chlorotriazine-series hardener include, though not limited to, 4,6-dichloro-2-hydroxy-1,3,5-triazine or its Na salt, 2-chloro-4,6-diphenoxytriazine, 2-chloro-4,6-bis[2,4,6-trimethylphenoxy]triazine, 2-chloro-4,6-diglycidoxy-1,3,5-triazine, 2-chloro-4-(n-butoxy)-6-glycidoxy-1,3,5-triazine, 2-chloro-4-(2,4,6-trimethylphenoxy)-6-glycidoxy-1,3,5-triazine, 2-chloro-4-(2-chloroethoxy)-6-(2,4,6-trimethylphenoxy)-1,3,5-triazine, 2-chloro-4-(2-bromoethoxy)-6-(2,4,6-trimethylphenoxy)-1,3,5-triazine, 2-chloro-4-(2-di-n-butylphosphateethoxy)-6-(2,4,6-trimethylphenoxy)-1,3,5-triazine and 2-chloro-4-(2-di-n-butylphosphateethoxy)-6-(2,6-xylenoxy)-1,3,5-triazine.

Such a compound can be easily produced by reacting cyanur chloride (namely, 2,4,6-trichlorotriazine) with, for example, a hydroxy compound, thio compound or amino compound corresponding to the substituent on the heterocycle.

These hardeners are preferably used in an amount of 0.001 to 1 g, and further preferably 0.005 to 0.5 g, per 1 g of the water-soluble polymer.

### (Emulsion)

An emulsion is preferably incorporated in the receptor layer of the heat-sensitive transfer image-receiving sheet of the present invention. The following is a detailed explanation of the emulsion that is preferably used in the present invention.

Hydrophobic additives, such as a releasing agent, an antioxidant, and the like, can be introduced into a layer of the image-receiving sheet (e.g. the receptor layer, the heat insulation layer, the undercoat layer), by using a known method described in U.S. Pat. No. 2,322,027, or the like. In this case, a high-boiling organic solvent, as described in U.S. Pat. No. 4,555,470, U.S. Pat. No. 4,536,466, U.S. Pat. No. 4,536,467, U.S. Pat. No. 4,587,206, U.S. Pat. No. 4,555,476 and U.S. Pat. No. 4,599,296, JP-B-3-62256, and the like, may be used singly or in combination with a low-boiling organic solvent having a boiling point of 50 to 160° C., according to the need. Also, these releasing agent, antioxidants, and high-boiling organic solvents may be respectively used in combination of two or more.

As the antioxidant, a compound represented by any one of the following formulae (E-1) to (E-3) is preferably used.

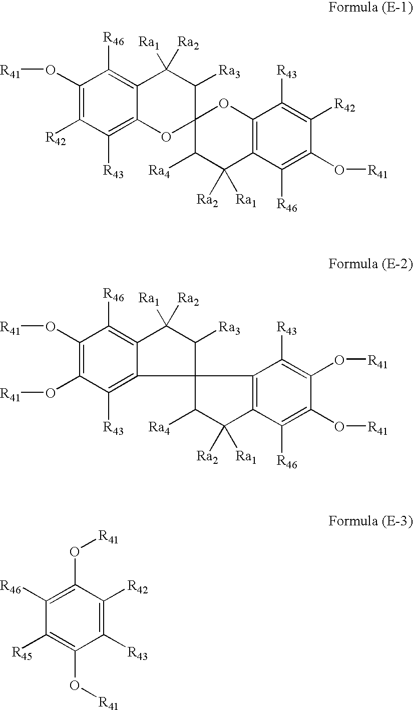

R₄₁ represents an aliphatic group, an aryl group, a heterocyclic group, an acyl group, an aliphatic oxycarbonyl group, an aryloxycarbonyl group, an aliphatic sulfonyl group, an arylsulfonyl group, a phosphoryl group, or a group —Si(R₄₇)(R₄₈)(R₄₉) in which R₄₇, R₄₈ and R₄₉ each independently represent an aliphatic group, an aryl group, an aliphatic oxy group, or an aryloxy group. R₄₂ to R₄₆ each independently represent a hydrogen atom, or a substituent. Examples of the substituent include a halogen atom, aliphatic group (including an alkyl group, alkenyl group, alkynyl group, cycloalkyl group, and cycloalkenyl group), aryl group, heterocyclic group, hydroxy group, mercapto group, aliphaticoxy group, aryloxy group, heterocyclic oxy group, aliphaticthio group, arylthio group, heterocyclic thio group, amino group, aliphaticamino group, arylamino group, heterocyclic amino group, acylamino group, sulfonamide group, cyano group, nitro group, carbamoyl group, sulfamoyl group, acyl group, aliphatic oxycarbonyl group, and aryloxycarbonyl group. Rₐ₁, Rₐ₂, Rₐ₃, and Rₐ₄ each independently represent a hydrogen atom, or an aliphatic group (for example, methyl, ethyl).

With respect to the compounds represented by any one of the Formulae (E-1) to (E-3), the groups that are preferred from the viewpoint of the effect to be obtained by the present invention, are explained below.

In the Formulae (E-1) to (E-3), it is preferred that R₄₁ represents an aliphatic group, an acyl group, an aliphatic oxycarbonyl group, an aryloxycarbonyl group, or a phosphoryl group, and R₄₂, R₄₃, R₄₅, and R₄₆ each independently represent a hydrogen atom, an aliphatic group, an aliphatic oxy group, or an acylamino group. It is more preferred that R₄₁ represents an aliphatic group, and R₄₂, R₄₃, R₄₅ and R₄₆ each independently represent a hydrogen atom or an aliphatic group.

Preferable specific examples of the antioxidants represented by any one of the Formulae (E-1) to (E-3) are shown below, but the present invention is not limited to these compounds.

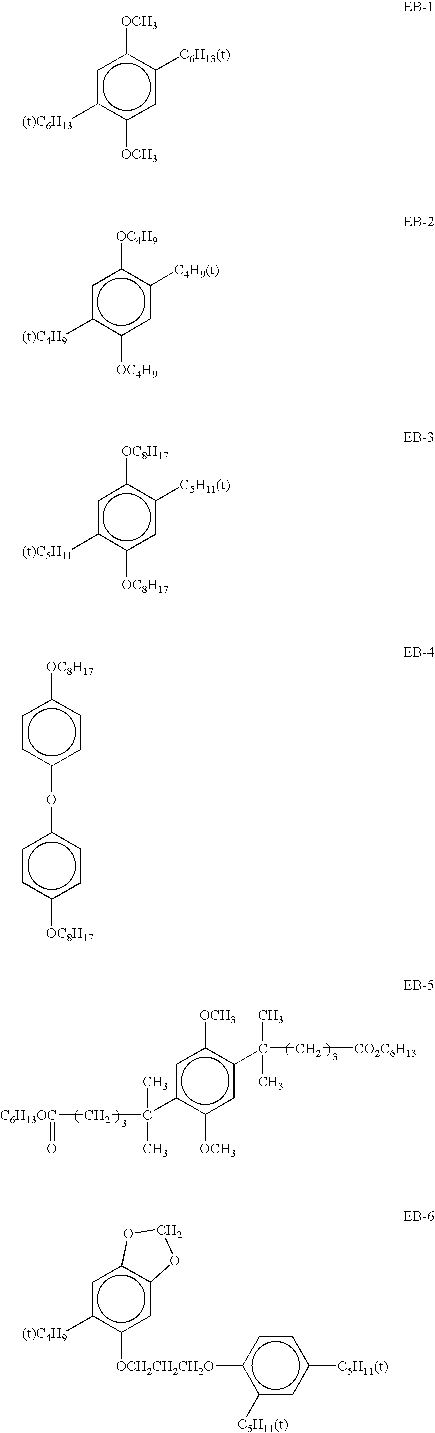

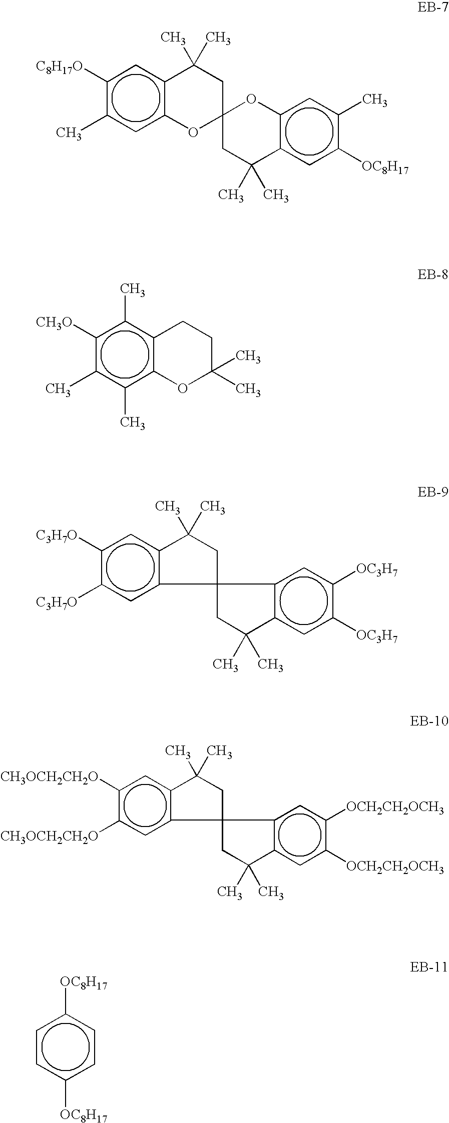

A content of the antioxidizing agent is preferably from 1.0 to 7.0 mass %, more preferably from 2.5 to 5.0 mass %, based on a solid content in the latex polymer.

Examples of the high-boiling organic solvent include phthalates (e.g., dibutyl phthalate, dioctyl phthalate, di-2-ethylhexyl phthalate), phosphates or phosphonates (e.g., triphenyl phosphate, tricresyl phosphate, tri-2-ethylhexyl phosphate), fatty acid esters (e.g., di-2-ethylhexyl succinate, tributyl citrate), benzoates (e.g., 2-ethylhexyl benzoate, dodecyl benzoate), amides (e.g., N,N-diethyldodecane amide, N,N-dimethylolein amide), alcohols or phenols (e.g., iso-stearyl alcohol, 2,4-di-tert-amyl phenol), anilines (e.g., N,N-dibutyl-2-butoxy-5-tert-octylaniline), chlorinated paraffins, hydrocarbons (e.g., dodecyl benzene, diisopropyl naphthalene), and carboxylic acids (e.g., 2-(2,4-di-tert-amyl phenoxy)butyrate).

Preferably the compounds shown below are used.

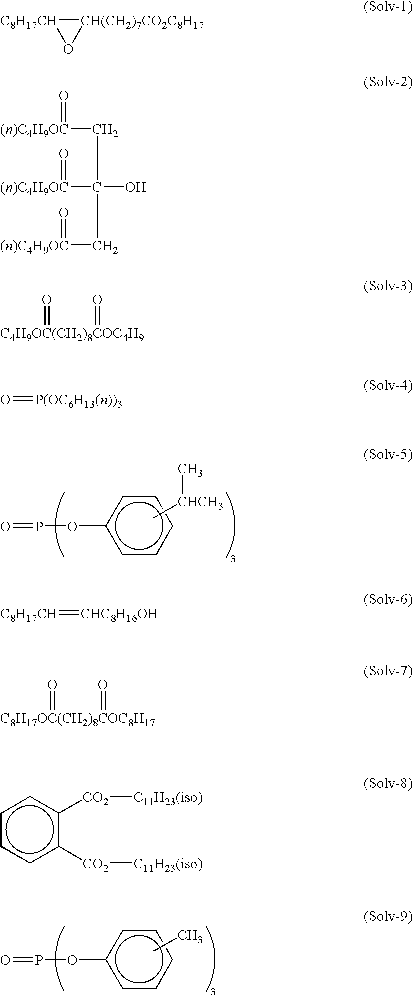

Further, the high-boiling organic solvent may be used in combination with, as an auxiliary solvent, an organic solvent having a boiling point of 30° C. or more and 160° C. or less, such as ethyl acetate, butyl acetate, methyl ethyl ketone, cyclohexanone, methylcellosolve acetate, or the like. The high-boiling organic solvent is used in an amount of generally 10 g or less, preferably 5 g or less, and more preferably 1 to 0.1 g, per 1 g of the hydrophobic additives to be used. The amount is also preferably 1 ml or less, more preferably 0.5 ml or less, and particularly preferably 0.3 ml or less, per 1 g of the binder.

A dispersion method that uses a polymer, as described in JP-B-51-39853 and JP-A-51-59943, and a method wherein the addition is made with them in the form of a dispersion of fine particles, as described in, for example, JP-A-62-30242, can also be used. In the case of a compound that is substantially insoluble in water, other than the above methods, a method can be used wherein the compound is dispersed and contained in the form of fine particles in a binder.

When the hydrophobic compound is dispersed in a hydrophilic colloid, various surfactants may be used. For example, those listed as examples of the surfactant in JP-A-59-157636, page (37) to page (38) may be used. It is also possible to use phosphates-based surfactants described in JP-A-7-56267, JP-A-7-228589, and West German Patent Application Laid-Open (OLS) No. 1,932,299A.

### (Ultraviolet Absorber)

Also, in the present invention, in order to improve light resistance, an ultraviolet absorber may be added to the receptor layer. In this case, when this ultraviolet absorber is made to have a higher molecular weight, it can be secured to the receptor layer so that it can be prevented, for instance, from being diffused into the ink sheet and from being sublimated and vaporized by heating.

As the ultraviolet absorber, compounds having various ultraviolet absorber skeletons, which are widely used in the field of information recording, may be used. Specific examples of the ultraviolet absorber may include compounds having a 2-hydroxybenzotriazole type ultraviolet absorber skeleton, 2-hydroxybenzotriazine type ultraviolet absorber skeleton, or 2-hydroxybenzophenon type ultraviolet absorber skeleton. Compounds having a benzotriazole-type or triazine-type skeleton are preferable from the viewpoint of ultraviolet absorbing ability (absorption coefficient) and stability, and compounds having a benzotriazole-type or benzophenone-type skeleton are preferable from the viewpoint of obtaining a higher-molecular weight and using in a form of a latex. Specifically, ultraviolet absorbers described in, for example, JP-A-2004-361936 may be used.

The ultraviolet absorber preferably absorbs light at wavelengths in the ultraviolet region, and the absorption edge of the absorption of the ultraviolet absorber is preferably out of the visible region. Specifically, when it is added to the receptor layer to form a heat-sensitive transfer image-receiving sheet, the heat-sensitive transfer image-receiving sheet has a reflection density of, preferably, Abs 0.5 or more at 370 nm, and more preferably Abs 0.5 or more at 380 nm. Also, the heat-sensitive transfer image-receiving sheet has a reflection density of, preferably, Abs 0.1 or less at 400 nm. If the reflection density at a wavelength range exceeding 400 nm is high, it is not preferable because an image is made yellowish.

The amount of the receptor layer to be applied is preferably 0.5 to 10 g/m² (solid basis, hereinafter, the amount to be applied in the present specification means a value on solid basis unless otherwise noted), more preferably 1 to 8 g/m², and further preferably 2 to 7 g/m². The film thickness of the receptor layer is preferably 1 to 20 μm.

### (Heat Insulation Layer)

The heat insulation layer serves to protect the support from heat when a thermal head or the like is used to carry out a transfer operation under heating. Also, because the heat insulation layer generally has proper cushion characteristics, a heat-sensitive transfer image-receiving sheet having high printing sensitivity can be obtained even in the case of using paper as a substrate (support). The heat insulation layer may be a single layer, or multi-layers. The heat insulation layer is generally arranged at a nearer location to the support than the receptor layer.

In the image-receiving sheet of the present invention, the heat insulation layer particularly preferably contains hollow polymer particles.

The hollow polymer particles in the present invention are polymer particles having independent pores inside of the particles. Examples of the hollow polymer particles include (1) non-foaming type hollow particles obtained in the following manner: a dispersion medium such as water is contained inside of a capsule wall formed of a polystyrene, acryl resin, or styrene/acryl resin and, after a coating solution is applied and dried, the dispersion medium in the particles is vaporized out of the particles, with the result that the inside of each particle forms a hollow; (2) foaming type microballoons obtained in the following manner: a low-boiling point liquid such as butane and pentane is encapsulated in a resin constituted of any one of polyvinylidene chloride, polyacrylonitrile, polyacrylic acid and polyacrylate, and their mixture or polymer, and after the resin coating material is applied, it is heated to expand the low-boiling point liquid inside of the particles whereby the inside of each particle is made to be hollow; and (3) microballoons obtained by foaming the above (2) under heating in advance, to make hollow polymer particles.

The particle size of the hollow polymer particles is preferably 0.1 to 20 μm, more preferably 0.1 to 2 μm, further preferably 0.1 to 1 μm, particularly preferably 0.2 to 0.8 μm. It is because an excessively small size may lead to decrease of the void ratio (hollow ratio) of the particles, prohibiting desirable heat-insulating efficiency, while an excessively large size in relation to the thickness of the heat insulation layer may result in problems for preparation of smooth surface and cause coating troubles due to the bulky particles.

In the present invention, these hollow polymer particles preferably have a hollow ratio of 20 to 70%, more preferably 20 to 50%. With too small hollow ratio, it cannot give a sufficient heat-insulating efficiency, while with an excessively large hollow ratio for the hollow particles that have the above-described preferable particle diameter, imperfect hollow particles increase prohibiting sufficient film strength.

The void ratio of the heat insulation layer as referred to here is a value V calculated according to the Formula (b) below.

$$P = \{ \frac{1}{n} \times {\sum }_{i = 1}^{n} {( Rai / Rbi )}^{3} \} \times 100 ( \% ) \qquad Formula ( b )$$

In formula (b), Rai represents the circle-equivalent diameter of the inner periphery (which shows the periphery of a hollow portion), among two peripheries constituting an image of a specific particle i; Rbi represents the circle-equivalent diameter of the outer periphery (which shows the outer shape of a particle in interest), among the two peripheries constituting the image of the specific particle i; and n is the number of measured particles, and n is generally 300 or more.

The glass transition temperature (Tg) of the hollow polymer particles is preferably 70° C. or more and more preferably 100° C. or more. These hollow polymer particles may be used in combinations of two or more.

Such hollow polymer particles are commercially available. Specific examples of the above (1) include Rohpake 1055 manufactured by Rohm and Haas Co.; Boncoat PP-1000 manufactured by Dainippon Ink and Chemicals, Incorporated; SX866(B) manufactured by JSR Corporation; and Nippol MH5055 manufactured by Nippon Zeon (all of these product names are trade names). Specific examples of the above (2) include F-30 and F-50 manufactured by Matsumoto Yushi-Seiyaku Co., Ltd. (all of these product names are trade names). Specific examples of the above (3) include F-30E manufactured by Matsumoto Yushi-Seiyaku Co., Ltd, and Expancel 461DE, 551DE and 551DE20 manufactured by Nippon Ferrite (all of these product names are trade names). Among these, the hollow polymer particles of the above (1) may be preferably used.

It is preferred that the latex polymer and/or the water-soluble polymer is contained in the heat insulation layer containing hollow polymer particles. The latex polymer and/or the water-soluble polymer that can be preferably used is the same as mentioned above. The addition amount of the water-soluble polymer in the heat insulation layer is preferably 1 to 75 mass %, preferably 1 to 50 mass % of the total amount of the heat insulation layer. It is preferred that gelatin is contained in the heat insulation layer The ratio by mass of the solid content of gelatin in the heat insulation layer in the coating liquid (solution) is preferably 0.5 to 14% by mass and more preferably 1 to 6% by mass. The content of the hollow polymer particles in the heat insulation layer is preferably from 1 g/m² to 100 g/m², more preferably from 5 g/m² to 20 g/m².

The solid content of the hollow polymer particles in the heat insulation layer preferably falls in a range from 5 to 2,000 parts by mass, more preferably 5 to 1000 parts by mass, and further preferably 5 to 400 parts by mass, assuming that the solid content of the latex polymer and/or the water-soluble polymer be 100 parts by mass. Also, the ratio by mass of the solid content of the hollow polymer particles in the coating liquid (solution) is preferably 1 to 70% by mass and more preferably 10 to 40% by mass. If the ratio of the hollow polymer particles is excessively low, sufficient heat insulation cannot be obtained, whereas if the ratio of the hollow polymer particles is excessively large, the adhesion between the hollow polymer particles is reduced, and thereby sufficient film strength cannot be obtained, causing deterioration in abrasion resistance.

Also, the water-soluble polymer that is contained in the heat insulation layer has been preferably cross-linked with a crosslinking agent. Preferable compounds as well as a preferable amount of the crosslinking agent to be used are the same as mentioned above.

A preferred ratio of a cross-linked water-soluble polymer in the heat insulation layer varies depending on the kind of the crosslinking agent, but the water-soluble polymer in the heat insulation layer is crosslinked by preferably 0.1 to 20 mass %, more preferably 1 to 10 mass %, based on the entire water-soluble polymer.

A thickness of the heat insulation layer containing the hollow polymer particles is preferably from 5 to 50 μm, more preferably from 5 to 40 μm.

A void ratio (porosity ratio) of the heat insulation layer, which is calculated from the thickness of the heat insulation layer containing hollow polymer particles and the solid-matter coating amount of the heat insulation layer including the hollow polymer particles, is preferably 10 to 70% and more preferably 15 to 60%. When the void ratio is too low, sufficient heat insulation property cannot be obtained. When the void ratio is too large, the binding force among hollow polymer particles deteriorates, and thus sufficient film strength cannot be obtained, and abrasion resistance deteriorates.

The void ratio of the heat insulation layer as referred to here is a value V calculated according to the Formula (c) below.

V=1−L/L×Σgi·di Formula (c)

In Formula (c), L represents the thickness of the heat-insulating layer; gi represents the coating amount of a particular material i in terms of solid matter for the heat-insulating layer; and di represents the specific density of the particular material i. When di represents the specific density of the hollow polymer particles, di is the specific density of the wall material of hollow polymer particles.

### (Undercoat Layer)

An undercoat layer may be formed between the receptor layer and the heat insulation layer. As the undercoat layer, for example, at least one of a white background controlling layer, a charge controlling layer, an adhesive layer, and a primer layer is formed. These layers may be formed in the same manner as those described in, for example, each specification of Japanese Patent Nos. 3585599 and 2925244.

### (Support)

In the present invention, any known support can be used. The use of the waterproof support makes it possible to prevent the support from absorbing moisture, whereby a fluctuation in the performance of the receptor layer with time can be prevented. As the waterproof support, for example, coated paper or laminate paper may be used.

### -Coated Paper-

The coated paper is paper obtained by coating a sheet such as base paper with various resins, rubber latexes, or high-molecular materials, on one side or both sides of the sheet, wherein the coating amount differs depending on its use. Examples of such coated paper include art paper, cast coated paper, and Yankee paper.

It is proper to use a thermoplastic resin as the resin to be applied to the surface(s) of the base paper and the like. As such a thermoplastic resin, the following thermoplastic resins (A) to (H) may be exemplified.

(A) Polyolefin resins such as polyethylene resin and polypropylene resin; copolymer resins composed of an olefin such as ethylene or propylene and another vinyl monomer; and acrylic resins.
(B) Thermoplastic resins having an ester linkage: for example, polyester resins obtained by condensation of a dicarboxylic acid component (such a dicarboxylic acid component may be substituted with a sulfonic acid group, a carboxyl group, or the like) and an alcohol component (such an alcohol component may be substituted with a hydroxyl group, or the like); polyacrylate resins or polymethacrylate resins such as polymethylmethacrylate, polybutylmethacrylate, polymethylacrylate, polybutylacrylate, or the like; polycarbonate resins, polyvinyl acetate resins, styrene acrylate resins, styrene-methacrylate copolymer resins, vinyltoluene acrylate resins, or the like.

Concrete examples of them are those described in JP-A-59-101395, JP-A-63-7971, JP-A-63-7972, JP-A-63-7973, and JP-A-60-294862.

Commercially available thermoplastic resins usable herein are, for example, Vylon 290, Vylon 200, Vylon 280, Vylon 300, Vylon 103, Vylon GK-140, and Vylon GK-130 (products of Toyobo Co., Ltd.); Tafton NE-382, Tafton U-5, ATR-2009, and ATR-2010 (products of Kao Corporation); Elitel UE 3500, UE 3210, XA-8153, KZA-7049, and KZA-1449 (products of Unitika Ltd.); and Polyester TP-220 and R-188 (products of The Nippon Synthetic Chemical Industry Co., Ltd.); and thermoplastic resins in the Hyros series from Seiko Chemical Industries Co., Ltd., and the like (all of these names are trade names).

(C) Polyurethane resins, etc.
(D) Polyamide resins, urea resins, etc.
(E) Polysulfone resins, etc.
(F) Polyvinyl chloride resins, polyvinylidene chloride resins, vinyl chloride/vinyl acetate copolymer resins, vinyl chloride/vinyl propionate copolymer resins, etc.
(G) Polyol resins such as polyvinyl butyral; and cellulose resins such as ethyl cellulose resin and cellulose acetate resin.
(H) Polycaprolactone resins, styrene/maleic anhydride resins, polyacrylonitrile resins, polyether resins, epoxy resins, and phenolic resins.

The thermoplastic resins may be used either alone or in combination of two or more.

The thermoplastic resin may contain a whitener, a conductive agent, a filler, a pigment or dye including, for example, titanium oxide, ultramarine blue, and carbon black; or the like, if necessary.

### -Laminated Paper-

The laminated paper is a paper which is formed by laminating various kinds of resin, rubber, polymer sheets or films on a sheet such as a base paper or the like. Specific examples of the materials useable for the lamination include polyolefins, polyvinyl chlorides, polyethylene terephthalates, polystyrenes, polymethacrylates, polycarbonates, polyimides, and triacetylcelluloses. These resins may be used alone, or in combination of two or more.

Generally, the polyolefins are prepared by using a low-density polyethylene. However, for improving the thermal resistance of the support, it is preferred to use a polypropylene, a blend of a polypropylene and a polyethylene, a high-density polyethylene, or a blend of a high-density polyethylene and a low-density polyethylene. From the viewpoint of cost and its suitableness for the laminate, it is preferred to use the blend of a high-density polyethylene and a low-density polyethylene.

The blend of a high-density polyethylene and a low-density polyethylene is preferably used in a blend ratio (a mass ratio) of 1/9 to 9/1, more preferably 2/8 to 8/2, and most preferably 3/7 to 7/3. When the thermoplastic resin layer is formed on the both surfaces of the support, the back side of the support is preferably formed using, for example, the high-density polyethylene or the blend of a high-density polyethylene and a low-density polyethylene. The molecular weight of the polyethylenes is not particularly limited. Preferably, both of the high-density polyethylene and the low-density polyethylene have a melt index of 1.0 to 40 g/10 minute and a high extrudability.

The sheet or film may be subjected to a treatment to impart white reflection thereto. As a method of such a treatment, for example, a method of incorporating a pigment such as titanium oxide into the sheet or film can be mentioned.

The thickness of the support is preferably from 25 μm to 300 μm, more preferably from 50 μm to 260 μm, and further preferably from 75 μm to 220 μm. The support can have any rigidity according to the purpose. When it is used as a support for electrophotographic image-receiving sheet of photographic image quality, the rigidity thereof is preferably near to that in a support for use in color silver halide photography.

### (Curling Control Layer)

When the support is exposed as it is, there is the case where the heat-sensitive transfer image-receiving sheet is made to curl by moisture and/or temperature in the environment. It is therefore preferable to form a curling control layer on the backside of the support. The curling control layer not only prevents the image-receiving sheet from curling but also has a water-proof function. For the curling control layer, a polyethylene laminate, a polypropylene laminate or the like is used. Specifically, the curling control layer may be formed in a manner similar to those described in, for example, JP-A-61-110135 and JP-A-6-202295.

### (Writing Layer and Charge Controlling Layer)

For the writing layer and the charge control layer, an inorganic oxide colloid, an ionic polymer, or the like may be used. As the antistatic agent, any antistatic agents including cationic antistatic agents such as a quaternary ammonium salt and polyamine derivative, anionic antistatic agents such as alkyl phosphate, and nonionic antistatic agents such as fatty acid ester may be used. Specifically, the writing layer and the charge control layer may be formed in a manner similar to those described in the specification of Japanese Patent No. 3585585.

The method of producing the heat-sensitive transfer image-receiving sheet in the present invention is explained below.

The heat-sensitive transfer image-receiving sheet in the present invention can be preferably formed, by applying at least one receptor layer, at least one intermediate layer and at least one heat-insulating layer, on a support, through simultaneous multi-layer coating.

It is known that in the case of producing an image-receiving sheet composed of plural layers having different functions from each other (for example, an air cell layer, a heat insulation layer, an intermediate layer and a receptor layer) on a support, it may be produced by applying each layer successively one by one, or by overlapping the layers each already coated on a support or substrate, as shown in, for example, JP-A-2004-106283, JP-A-2004-181888 and JP-A-2004-345267. It has been known in photographic industries, on the other hand, that productivity can be greatly improved, for example, by providing plural layers through simultaneous multi-layer coating. For example, there are known methods such as the so-called slide coating (slide coating method) and curtain coating (curtain coating method) as described in, for example, U.S. Pat. Nos. 2,761,791, 2,681,234, 3,508,947, 4,457,256 and 3,993,019; JP-A-63-54975, JP-A-61-278848, JP-A-55-86557, JP-A-52-31727, JP-A-55-142565, JP-A-50-43140, JP-A-63-80872, JP-A-54-54020, JP-A-5-104061, JP-A-5-127305, and JP-B-49-7050; and Edgar B. Gutoff, et al., “Coating and Drying Defects: Troubleshooting Operating Problems”, John Wiley & Sons Company, 1995, pp. 101-103; and “LIQUID FILM COATING”, CHAPMAN & HALL, 1997, pp. 401-536.

In the present invention, it is preferred that at least two layers adjacent to each other, especially at least two layers of at least one heat insulation layer and at least one receptor layer adjacent to each other are simultaneously multilayer coated so that the effects aimed by the present invention can be effectively obtained. In the present invention, it has been found that the productivity is greatly improved and, at the same time, image defects can be remarkably reduced, by using the above simultaneous multilayer coating for the production of an image-receiving sheet having a multilayer structure.

The plural layers in the present invention are structured using resins as its major components. Coating solutions forming each layer are preferably water-dispersible latexes. The solid content by mass of the resin put in a latex state in each layer coating solution is preferably in a range from 5 to 80% and particularly preferably 20 to 60%. The average particle diameter of the resin contained in the above water-dispersed latex is preferably 5 μm or less and particularly preferably 1 μm or less. The above water-dispersed latex may contain a known additive, such as a surfactant, a dispersant, and a binder resin, according to the need.

In the present invention, it is preferred that a laminate composed of plural layers be formed on a support and solidified just after the forming, according to the method described in U.S. Pat. No. 2,761,791. For example, in the case of solidifying a multilayer structure by using a resin, it is preferable to raise the temperature immediately after the plural layers are formed on the support. Also, in the case where a binder (e.g., a gelatin) to be gelled at lower temperatures is contained, there is the case where it is preferable to drop the temperature immediately after the plural layers are formed on the support.

In the present invention, the coating amount of a coating solution per one layer constituting the multilayer is preferably in a range from 1 g/m² to 500 g/m². The number of layers in the multilayer structure may be arbitrarily selected from a number of 2 or more. The receptor layer is preferably disposed as a layer most apart from the support.

In the image-forming method (system) of the present invention, thermal transfer imaging is achieved by superposing a heat-sensitive (thermal) transfer sheet on a heat-sensitive (thermal) transfer image-receiving sheet so that a heat transfer layer of the heat-sensitive transfer sheet is in contact with a receptor layer of the heat-sensitive transfer image-receiving sheet and giving thermal energy in accordance with image signals.

Specifically, image-forming can be achieved by the similar manner to that as described in, for example, JP-A-2005-88545. In the present invention, a printing time is preferably less than 15 seconds, and more preferably in the range of 5 to 12 seconds, from the viewpoint of shortening a time taken until a consumer gets a print.

The system of the present invention can be applied to a printer, a copying machine and the like, each of which uses a heat-sensitive transfer recording system.

As a means for providing heat energy in the thermal transfer, any of the conventionally known providing means may be used. For example, application of a heat energy of about 5 to 100 mJ/mm² by controlling recording time in a recording device such as a thermal printer (trade name: Video Printer VY-100, manufactured by Hitachi, Ltd.), sufficiently attains the expected result.

Also, the heat-sensitive transfer image-receiving sheet of the present invention may be used in various applications enabling thermal transfer recording, such as heat-sensitive transfer image-receiving sheets in a form of thin sheets (cut sheets) or rolls; cards; and transmittable type manuscript-making sheets, by optionally selecting the type of support.

The present invention enables to provide a heat-sensitive transfer sheet that is hard to cause irregular transfer in a thermal transferable protective layer and that is capable of forming an image having an excellent print image quality and high glossiness, and an image-forming method using the same.

The present invention will be described in more detail based on the following examples, but the invention is not intended to be limited thereto. In the following examples, the terms “part(s)” and “%” are values by mass, unless otherwise specified.

### EXAMPLES

### Preparation of Ink Sheet

### (Preparation of Substrates A to C for Preparation of Ink Sheet)

### (Preparation of Substrate A)

A polyester film 6.0 μm in thickness (trade name: Lumirror, manufactured by Toray Industries, Inc.) was used as the substrate film. A heat-resistant slip layer (thickness: 1 μm) was formed on the back side of the film, thereby preparing Substrate A.

### (Preparation of Substrate B)

Substrate B was prepared by using as a substrate film a polyester film (trade name: Lumirror, manufactured by Toray Industries, Inc.) used in the preparation of substrate A, and treating one surface of the substrate film using an atmospheric pressure plasma processor AP-T02-L (manufactured by Sekisui Chemical Co., Ltd.), and thereafter forming a heat-resistant slip layer (thickness 1 μm) on a back side of the film.

### (Preparation of Substrate C)

Substrate C was prepared in the same manner as in the preparation of Substrate B, except for change of the gas that was used in the atmospheric pressure plasma processing.

The conditions used in the atmospheric pressure plasma processing in the preparation of substrates B and C are shown in Table 1.

TABLE 1

| | Processing | | Applied voltage pulse |
|---|---|---|---|
| | speed/mm/min | Gas being used | frequency/KHz |
| B | 100 | N₂ 100% | 30 |
| C | 100 | N₂ (97%) + O₂ (3%) | 30 |

### (Preparation of Heat-Sensitive Transfer Sheets A1 to C1)

Ink sheets were prepared by applying the following yellow, magenta and cyan compositions as a monochromatic layer (coating amount: 1 g/m² after drying) onto the surface (front) side of the above-described substrates A to C, respectively. A protective sheet was prepared by coating the following releasing layer, peeling layer, protective layer and adhesion layer, so as to become coating amounts at a dry state of 0.3 μm, 1 μm and 1 μm, respectively. Thus, heat-sensitive transfer sheets A1 to C1 were prepared.

### Ink Sheet

| | |
|---|---|
| Yellow ink composition | |
| Dye compound (YS-1) | 5.4 parts by mass |
| Polyvinylbutyral resin (trade name: ESLEC BX-1, | 4.5 parts by mass |
| manufactured by Sekisui Chemical Co., Ltd.) | |
| Methyl ethyl ketone/toluene (1/1, at mass ratio) | 90 parts by mass |
| Magenta ink composition | |
| Dye compound (MS-1) | 5.9 parts by mass |
| Polyvinylbutyral resin (trade name: ESLEC BX-1, | 4.5 parts by mass |
| manufactured by Sekisui Chemical Co., Ltd.) | |
| Methyl ethyl ketone/toluene (1/1, at mass ratio) | 90 parts by mass |
| Cyan ink composition | |
| Dye compound (CS-1) | 6.3 parts by mass |
| Polyvinylbutyral resin (trade name: ESLEC BX-1, | 4.5 parts by mass |
| manufactured by Sekisui Chemical Co., Ltd.) | |
| Methyl ethyl ketone/toluene (1/1, at mass ratio) | 90 parts by mass |

### Protective Layer

| | |
|---|---|
| Releasing layer | |
| Polyvinyl alcohol resin (trade name: GOHSENOL | 5 parts by mass |
| A300, manufactured by Nippon Synthetic Chemical | |
| Industry) | |
| Ethanol/water (1/1, at mass ratio) | 95 parts by mass |
| Peeling layer | |
| Acrylic resin (DIANAL BR-80, trade name, a | 20 parts by mass |
| product of Mitsubishi Rayon) | |
| Methyl ethyl ketone/toluene (1/1, at mass ratio) | 80 parts by mass |
| Adhesion layer | |
| Polyester resin (Trade name: Vylon 220, | 30 parts by mass |
| manufactured by Toyobo Co., Ltd.) | |
| Methyl ethyl ketone/toluene (1/1, at mass ratio) | 70 parts by mass |

The chemical structures of the dye compounds YS-1, MS-1 and CS-1 used for preparing the ink sheet are shown below.

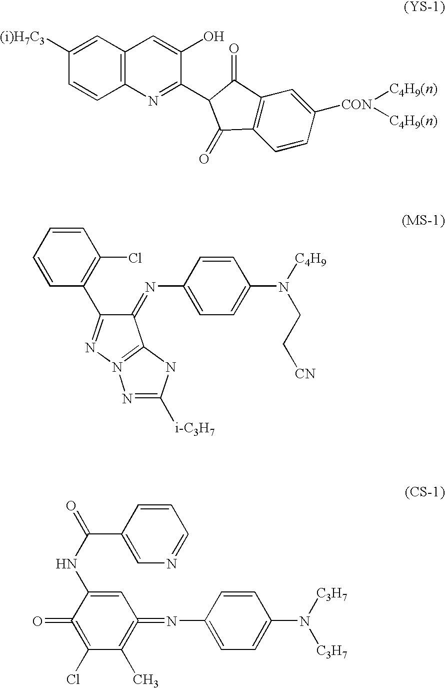

### [Preparation of Heat-Sensitive Transfer Image-Receiving Sheet]

### Preparation of Image-Receiving Sheet 101

A heat insulation layer resin having the following composition was hot melt extruded in a form of 50 μm thick film from a T die. Thereafter, the resultant extruded resin was subjected to an extraction processing with a supercritical CO₂ gas in a high pressure chamber under the conditions of 40° C., 15 MPa and 10 min, followed by a rapid pressure reduction to atmospheric pressure. Thus, a perforated substrate of a heat-insulation film having multiple fine voids was obtained.

(Heat insulation layer resin)

| | |
|---|---|
| Polypropylene resin (trade name: F329RA, | 50 parts by mass |
| manufactured by Mitsui Chemicals) | |
| Terpene resin (trade name: Clearon P-125, | 50 parts by mass |
| manufactured by YASUHARA CHEMICAL) | |

On one side of the substrate, were coated and dried the following interlayer and dye receptor layer by a gravure coat so as to become coating amounts of 2.0 g/m² and 4.0 g/m² in terms of dry state respectively. Subsequently, basis weight 158 g/m² of a coated paper and a back side (non-coated surface) of the above-described substrate were stuck together by a dry laminate method, thereby obtaining a thermal transfer image-receiving sheet 101.

(Composition of Interlayer-coating liquid)

| | |
|---|---|
| Polyester resin (Trade name: Vylon 200, | 10 parts by mass |
| manufactured by Toyobo Co., Ltd.) | |
| Titanium oxide (trade name: TCA-888, | 20 parts by mass |
| manufactured by Tohkem) | |
| Methyl ethyl ketone/toluene (1/1, at mass ratio) | 120 parts by mass |

(Composition of Dye receptor layer-coating liquid)

| | |
|---|---|
| Vinyl chloride/vinyl acetate copolymer (Trade name: | 100 parts by mass |
| # 1000A, manufactured by DENKIKAGAKU | |
| KOGYO K. K.) | |
| Amino-modified silicone (Trade name: X22-3050C, | 5 parts by mass |
| manufactured by Shin-Etsu Chemical Co., Ltd.) | |
| Epoxy-modified silicone (Trade name: X22-300E, | 5 parts by mass |
| manufactured by Shin-Etsu Chemical Co., Ltd.) | |
| Methyl ethyl ketone/toluene (1/1, at mass ratio) | 400 parts by mass |

### Preparation of Image-Receiving Sheet 102

### (Preparation of Emulsion A)

An emulsion A was prepared in the following manner. An antioxidant (EB-9) was dissolved in a mixture of 42 g of a high-boiling solvent (Solv-5) and 20 ml of ethyl acetate, and the resultant solution was emulsified and dispersed in 250 g of a 20-mass % aqueous gelatin solution containing 1 g of sodium dodecylbenzenesulfonate, by means of a high-speed stirring emulsifier (dissolver). Thereto, water was added, to prepare 380 g of the emulsified dispersion A.

Samples 102 were prepared by coating, on the support which was already prepared in the foregoing manner, to form a multilayer structure having a subbing layer 1, a subbing layer 2, a heat insulation layer, and a receptor layer, in increasing order of distance from the support. The compositions and coated amounts of the coating liquids (solutions) to be used are shown below.

The simultaneous multi-layer coating was carried out, according to the slide coating method described in the aforementioned “LIQUID FILM COATING” p. 427; and after coating, the thus-coated products were passed through a set zone at 6° C. for 30 seconds to lose fluidity, followed by drying by spraying a drying air at 22° C. and 45% RH on the coated surface for 2 minutes.

| | |
|---|---|
| Coating liquid (solution) for subbing layer 1 | |
| (Composition) | |
| Aqueous solution, prepared by adding 1% of sodium dodecylbenzenesulfonate to a 3 | |
| mass % aqueous gelatin solution | |
| NaOH for adjusting pH to 8 | |
| (Coating amount) | 11 ml/m² |
| Coating solution for subbing layer 2 | |
| (Composition) | |
| Styrene-butadiene latex (SR103 (trade name), manufactured by Nippon A & L Inc.) | 60 parts by mass |
| 6% Aqueous solution of polyvinyl alcohol (PVA) | 40 parts by mass |
| NaOH for adjusting pH to 8 | |
| (Coating amount) | 11 ml/m² |
| Coating solution for heat insulation layer | |
| (Composition) | |
| Hollow latex polymer particles | 60 parts by mass |
| (MH5055 (trade name), manufactured by Nippon Zeon Corporation) | |
| 10 mass % Gelatin aqueous solution | 20 parts by mass |
| Emulsified dispersion A prepared in the above | 20 parts by mass |
| NaOH for adjusting pH to 8 | |
| (Coating amount) | 45 ml/m² |
| Coating solution for receptor layer | |
| (Composition) | |
| Vinyl chloride-latex polymer | 50 parts by mass |
| (VINYBLAN 900 (trade name), manufactured by Nissin Chemical Industry Co., | |
| Ltd.) | |
| Vinyl chloride-latex polymer | 20 parts by mass |
| (VINYBLAN 609 (trade name), manufactured by Nissin Chemical Industry Co., | |
| Ltd.) | |
| 10 mass % Gelatin aqueous solution | 10 parts by mass |
| Emulsified dispersion A prepared in the above | 10 parts by mass |
| Wax dispersions described in Table 2 (Addition amount described in Table 3) | |
| Water | 5 parts by mass |
| Compond X (Cross-linking agent) | 1 parts by mass |
| NaOH for adjusting pH to 8 | |
| (Coating amount) | 18 ml/m² |

Compound X

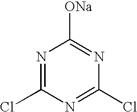

### Preparation of Image-Receiving Sheet 103

Image-receiving sheet 103 was prepared in the same manner as image-receiving sheet 102, except that gelatin of the heat-insulation layer was replaced by a water-soluble polyester resin (Trade name: VYRONAL MD 1200, manufactured by Toyobo Co., Ltd.).

### (Evaluation of Irregular Transfer of Protective Layer Followed by Image Formation)

Heat-sensitive transfer materials were prepared by combining transfer sheets A1 to C1 and image-receiving sheets of the above-described samples 101 to 103 as shown in Table 2, and they were processed so as to make them loadable in a sublimation type printer DPB 2000 (trade name) manufactured by Nidec Copal Corporation. A black solid image and tone images of yellow, magenta and cyan were output, and then the output prints were evaluated by naked eye with respect to irregular transfer of the ink sheet and the protective layer. Evaluation of irregular transfer was performed by classifying the output prints into five grades of from 1 to 5 according to their levels of occurrence of the irregular transfer.

5 indicates no occurrence of irregular transfer, so that transfer state is good.
4 indicates slightly occurrence of irregular transfer, which can be hardly found by naked eye, so that transfer state is good.
3 indicates partly occurrence of irregular transfer, which can be obviously found by naked eye, so that quality is insufficient.
2 indicates obviously occurrence of irregular transfer, so that quality is insufficient.
1 indicates completely occurrence of irregular transfer, so that quality is insufficient.

Further, measurement and evaluation of glossiness were performed with respect to the black solid image in which there is no irregular transfer.

### (Evaluation of Glossiness)

### 1. Regular Reflection Intensity

With respect to the black solid image in which there is no irregular transfer, varied angle measurement was performed at the following incident angle and acceptance angle under the measuring conditions set forth below using a glossimeter (a digital variable gross meter UGV-5D; manufactured by SUGA TEST INSTRUMENTS CO., LTD). Thereby a peak value of the reflection intensity was obtained. The thus obtained peak value was employed as regular reflection intensity for evaluation of glossiness.

### <Measuring Conditions>

Incident angle: 45°

Acceptance angle: 30° to 60°

Calibration method: black standard reflector (refractive index 1.508)

### 2. Feeling of Gloss

With respect to the black solid image that was used for the above-described regular reflection intensity measurement, a feeling of gloss was evaluated by naked eye according to the following criterion for evaluation.

### [Criterion for Evaluation]

5 - - - excellent feeling of gloss

4 - - - almost good feeling of gloss

3 - - - slight feeling of gloss all over the surface

2 - - - locally slight feeling of gloss

1 - - - beyond evaluation

TABLE 2

| | | Heat-sensitive |
|---|---|---|
| | Heat-sensitive | transfer image- |
| Sample No. | transfer sheet | receiving sheet |
| 1 (Comparative example) | A1 | 101 |
| 2 (Comparative example) | A1 | 102 |
| 3 (Comparative example) | A1 | 103 |
| 4 (This example) | B1 | 101 |
| 5 (This example) | B1 | 102 |
| 6 (This example) | B1 | 103 |
| 7 (This example) | C1 | 101 |
| 8 (This example) | C1 | 102 |
| 9 (This example) | C1 | 103 |

Evaluation results that were obtained by each of combinations set forth above were shown in Table 3.

TABLE 3

| | | | Results of regular | |
|---|---|---|---|---|
| | Irregular | Irregular | reflection measurement | Results of |
| | transfer of | transfer of | (with exception of | evaluation of |
| Sample No. | ink sheet | protective layer | irregular transfer) | feeling of gloss |
| 1 (Comparative example) | 4 | 2 | 60 | 2 |
| 2 (Comparative example) | 3 | 1 | 49 | 1 |
| 3 (Comparative example) | 3 | 1 | 52 | 1 |
| 4 (This example) | 5 | 5 | 75 | 4 |
| 5 (This example) | 5 | 5 | 82 | 5 |
| 6 (This example) | 5 | 5 | 78 | 5 |
| 7 (This example) | 5 | 5 | 78 | 4 |
| 8 (This example) | 5 | 5 | 84 | 5 |
| 9 (This example) | 5 | 5 | 81 | 5 |

As is apparent from the results shown in the above Table 3, irregular transfers of the ink sheet and the protective layer occurred to samples 1 to 3 of comparative example. And also, samples 1 to 3 of comparative example were inferior in a feeling of gloss.

On the other hand, it is understood that the heat-sensitive transfer sheets of the present invention not only are difficult to cause both irregular transfers of the ink sheet and the protective sheet but also are excellent in glossiness.

Having described our invention as related to the present embodiments, it is our intention that the invention not be limited by any of the details of the description, unless otherwise specified, but rather be construed broadly within its spirit and scope as set out in the accompanying claims.

1. A heat-sensitive transfer sheet comprising at least three different kinds of heat-sensitive transfer dye layers each comprising at least one yellow, magenta or cyan dye and at least one binder resin, provided on a support, and at least one thermal transferable protective layer capable of peeling, comprising a releasing layer, a peeling layer and an adhesion layer, provided on the support in this order, and
wherein a surface of the support to which the releasing layer of said protective layer adheres has been subjected to an atmospheric pressure plasma treatment.

2. The heat-sensitive transfer sheet according to claim 1, wherein gas for use in said atmospheric pressure plasma treatment is a mixed gas substantially consisting of nitrogen and oxygen.

3. The heat-sensitive transfer sheet according to claim 1, wherein said at least three heat-sensitive transfer dye layers are formed panel sequentially, on the surface of the same support.

4. The heat-sensitive transfer sheet according to claim 1, wherein each of said at least three heat-sensitive transfer dye layers and said thermal transferable protective layer is formed panel sequentially, on the surface of the same support.

5. An image-forming method using a combination of the heat-sensitive transfer sheet according to claim 1 and a heat-sensitive transfer image-receiving sheet, wherein said heat-sensitive transfer image-receiving sheet has a support, at least one receptor layer on the support and at least one heat insulation layer containing hollow polymer particles between the receptor layer and the support, and
wherein the receptor layer and/or the heat insulation layer contains a hydrophilic polymer.

6. The image-forming method according to claim 5, wherein gas for use in said atmospheric pressure plasma treatment is a mixed gas substantially consisting of nitrogen and oxygen.

7. The image-forming method according to claim 5, wherein said at least three heat-sensitive transfer dye layers are formed panel sequentially, on the surface of the same support.

8. The image-forming method according to claim 5, wherein each of said at least three heat-sensitive transfer dye layers and said thermal transferable protective layer is formed panel sequentially, on the surface of the same support.

9. The image-forming method according to claim 5, wherein at least one of the hydrophilic polymer contained in the heat-sensitive transfer image-receiving sheet is gelatin.

10. The image-forming method according to claim 5, which comprises coating at least two layers adjacent to each other of said at least one heat insulation layer and said at least one receptor layer by a simultaneous multilayer coating in the heat-sensitive transfer image-receiving sheet.

11. The image-forming method according to claim 5, comprising the steps of:
superposing the heat-sensitive transfer sheet on the heat-sensitive transfer image-receiving sheet so that the receptor layer of the heat-sensitive transfer image-receiving sheet is in contact with the heat-sensitive transfer dye layer of the heat-sensitive transfer sheet; and
giving thermal energy from a thermal head in accordance with image signals, thereby to form an image.
